(19) United States
(12) Patent Application Publication
(10) Pub. No.: US 2005/0080701 A1
(43) Pub. Date: Apr. 14, 2005

(54) Methods and systems for managing risk management information

(75) Inventors: Joseph Patrick Tunney, Weston, CT (US); James Charles Ungari, Westport, CT (US); Stephen Anthony Papalas, Evanston, IL (US); Kathleen Mary Chomienne, Alpharetta, GA (US); Paul Anthony Vitti, Danbury, CT (US)

Correspondence Address: John S. Beulick;ARMSTRONG TEASDALE LLP, Suite 2600, One Metropolitan Square, St. Louis, MO, 63102, US

(73) Assignee: GE Corporate Financial Services, Inc.

(21) Appl. No.: 11/005,748

(22) Filed: Dec. 7, 2004

Related U.S. Application Data
(63) Continuation-in-part of application No. 10/329,309, filed on Dec. 23, 2002.
(60) Provisional application No. 60/605,323, filed on Aug. 27, 2004.

(51) Int. Cl. G06F 17/60

(52) U.S. Cl. 705/35; 705/30

(57) ABSTRACT

A method for managing business information and account strategy by a business entity is provided. The method uses a computer system coupled to a database. The method includes receiving at the computer system information including historical financial data relating to at least one customer of the business entity, and entering into the computer at least one risk factor including at least one of a deal driver, a tracking source, a tracking frequency, a target metric, a trigger level, an impact of factor, and corresponding action plan wherein the risk factor indicating a risk associated with the business entity providing financing to the customer. The method further includes updating the database periodically with newly received information, and monitoring the at least one deal driver to determine whether to alter a current account strategy being applied by the business entity to the customer including updating a buy/hold/sell plan.

### CROSS REFERENCE TO RELATED APPLICATIONS

This application is a continuation in part of U.S. patent application Ser. No. 10/329,309, filed Dec. 23, 2002, and claims priority to provisional patent application No. 60/605,323, filed Aug. 27, 2004, which both are hereby incorporated by reference in their entirety.

### BACKGROUND OF THE INVENTION

This invention relates generally to managing risk management information and, more particularly, to network-based methods and systems for managing risk management information.

Businesses engaging in complex deals, such as commercial financing, mergers, acquisitions and real estate transactions, generally conduct a due diligence analysis to access the financial strength, operational characteristics of a business, collateral and/or business value, management strength, industry dynamics, and the proposed structure of the transaction and the party or parties involved in the deal. The due diligence analysis facilitates the financing business to better evaluate and manage the risk associated with the deal after the transaction closes.

During a due diligence analysis, information, known as risk management (RM) information, is gathered from many sources. RM information is often complex and relates to various relevant areas of the overall transaction. Therefore, a number of different members of a due diligence team may need to know the same RM information in evaluating the deal. Internal deal teams typically manually and individually collect data as part of the due diligence analysis. The efforts are often duplicated, and as such, the data may be entered multiple times on multiple different systems throughout the financing business. For example, in a transaction involving the lending on accounts receivable and inventory to secure a formula based loan to a business, both an underwriting team and a legal team may be involved. The underwriting team may be focused on (i) what the collateral is, the value of the collateral, and how the collateral is valued, (ii) the financial strength and operation of the business, (iii) the management strength, (iv) the overall structure of the transaction, and (v) other factors relating to the business, industry, and collateral involved in the deal. The legal team may be focused on (i) the location of the collateral, (ii) the structure of the transaction, (iii) an understanding of the legal entities involved, and (iv) other legal factors surrounding the business, industry and collateral involved in the deal. During the due diligence analysis, both the underwriting and the legal teams will collect certain RM information to be evaluated. Although the underwriting team and the legal team may have different concerns when evaluating the RM information, much of the RM information being evaluated is the same.

Individual collection of RM information by various internal deal teams increases the risk of overlapping data collection and decreases time efficiency. Further, individual reporting by internal teams to other internal teams or external teams increases the risk of providing inconsistent or incomplete data during the documentation process, which may result in increased cycle time and costs. For example, in the collateral transaction described above, external legal counsel may request information relating to the location of the collateral from the borrower. The underwriting team may also request information from the borrower regarding the location of the collateral. Because the information is collected both manually and individually, the underwriting team may have no knowledge that the data had been previously collected by the legal team. Consequently, documentation cycle time and costs are increased. Additionally, because various deal teams may collect the RM information, the RM information may not be centralized for future monitoring and management.

During the underwriting process, the financing business may also use the RM information to (i) project an expected financial scenario for at least one of the parties involved in a transaction, and (ii) designate risk factors to be monitored by the financing business. Being able to compare the expected financial scenario for a business entity with actual financial results of the same business entity at some point in time after the transaction has been completed enables the financing business to review its process of projecting the expected financial scenario and implement changes to its underwriting processes. Moreover, by monitoring risk factors, the financing business is able to monitor its investments.

### BRIEF DESCRIPTION OF THE INVENTION

In one aspect, a method for managing business information and account strategy by a business entity is provided. The method uses a computer system coupled to a database. The method includes receiving at the computer system information including historical financial data relating to at least one customer of the business entity, and entering into the computer at least one risk factor including at least one of a deal driver, a tracking source, a tracking frequency, a target metric, a trigger level, an impact of factor, and corresponding action plan wherein the risk factor indicating a risk associated with the business entity providing financing to the customer. The method further includes updating the database periodically with newly received information, and monitoring the at least one deal driver to determine whether to alter a current account strategy being applied by the business entity to the customer including updating a buy/hold/sell plan.

In another aspect, a method for managing business information and account strategy by a business entity is provided. The method uses a computer system coupled to a database. The method includes receiving at the computer system information including historical financial data relating to at least one customer of the business entity, storing the information received at the computer system in the database, generating at least one financial scenario for the customer based on the received information wherein the at least one financial scenario including projected financial data for the customer, and entering into the computer at least one risk factor including at least one of a deal driver, a tracking source, a tracking frequency, a target metric, a trigger level, an impact of factor, and corresponding action plan. The risk factor indicates a risk associated with the business entity providing financing to the customer. The deal driver is assigned by the business entity during an underwriting process associated with the financing of the customer and includes a financial variable representing a level of strength of the customer's business. The trigger level is assigned to a deal driver by the business entity during the underwriting process associated with the financing of the customer and is a threshold level. The method further includes storing the at least one financial scenario and the at least one risk factor in the database, updating the database periodically with newly received business information including actual financial data for the customer to maintain the database, calculating a variance for the customer by comparing the projected financial data from the generated financial scenario to the actual financial data, and monitoring the at least one deal driver to determine whether to alter a current account strategy being applied by the business entity to the customer including updating a buy/hold/sell plan.

In another aspect, a network based system for managing business information and account strategy by a business entity is provided. The system includes a client system having a browser, a centralized database for storing information, and a server system configured to be coupled to the client system and the database. The server system is further configured to receive from the client system information including historical financial data relating to at least one customer of the business entity, store the information in the database, and prompt a user to enter using the client system at least one risk factor including at least one of a deal driver, a tracking source, a tracking frequency, a target metric, a trigger level, an impact of factor, and corresponding action plan. The risk factor indicates a risk associated with the business entity providing financing to the customer. The server system is further configured to store the at least one risk factor in the database, update the database periodically with newly received information including actual financial data for the customer to maintain the database, and monitor the at least one deal driver to determine whether to alter a current account strategy being applied by the business entity to the customer including updating a buy/hold/sell plan.

In another aspect, a computer program embodied on a computer readable medium for managing business information and account strategy by a business entity providing financing to a customer is provided. The program includes at least one code segment that receives information including historical financial data relating to at least one customer of the business entity and then stores the information in a database. The program also includes at least one code segment that prompts a user to enter at least one risk factor including at least one of a deal driver, a tracking source, a tracking frequency, a target metric, a trigger level, an impact of factor, and corresponding action plan. The risk factor indicates a risk associated with the business entity providing financing to the customer. The program further includes at least one code segment stores the at least one risk factor in the database, updates the database periodically with newly received information including actual financial data for the customer to maintain the database, monitors the at least one deal driver, and recommends whether to alter a current account strategy being applied by the business entity to the customer including updating a buy/hold/sell plan.

### BRIEF DESCRIPTION OF THE DRAWINGS

FIG. 1 is a simplified block diagram of a Risk Management Coordination System (RMCS) in accordance with one embodiment of the present invention.

FIG. 2 is an expanded version block diagram of an example embodiment of a server architecture of the RMCS.

FIG. 3 shows a configuration of a database within a database server of a server system including other related server components.

FIG. 4 is a block diagram of RMCS in communication with a cash flow forecasting tool.

FIGS. 5A and 5B show a flowchart illustrating example processes utilized by RMCS.

FIG. 6 is an example embodiment of a user interface displaying a login page included within a RMCS.

FIGS. 7A and 7B show an example embodiment of a user interface displaying a home page included within a RMCS.

FIG. 8 is an example embodiment of a user interface displaying a financial performance summary page included within a RMCS.

FIGS. 9A-9C show an example embodiment of user interface displaying a general setup page included within a RMCS.

FIG. 10 is an example embodiment of user interface displaying a capital structure page for an analyzed business included within a RMCS.

FIG. 11 is an example embodiment of user interface displaying a collateral setup page included within a RMCS.

FIG. 12 is an example embodiment of user interface displaying a covenants setup page for a selected account included within a RMCS.

FIGS. 13A-13B show an example embodiment of user interface displaying an equity setup page included within a RMCS.

FIG. 14 is an example embodiment of user interface displaying a deal drivers setup page for a selected account included within a RMCS.

FIG. 15 is an example embodiment of user interface displaying an asset-based Portfolio Management Report (PMR) page for a selected account included within a RMCS.

FIG. 16 is an example embodiment of a user interface displaying a deal driver data input page for a selected account included within a RMCS.

FIG. 17 is an example embodiment of a user interface displaying an historical data input pop-up window included within a RMCS.

FIG. 18 is an example embodiment of a user interface displaying a deal driver approval/alert page included within a RMCS.

FIG. 19 is an example embodiment of a user interface displaying a deal driver alert page included within a RMCS.

FIG. 20 is an example embodiment of a user interface displaying a deal driver report page included within a RMCS.

FIG. 21 is an example embodiment of a user interface displaying a financial trends report page included within a RMCS.

FIG. 22 is an example embodiment of a user interface displaying a Buy/Sell/Hold page included within a RMCS.

### DETAILED DESCRIPTION OF THE INVENTION

Example embodiments of systems and processes that facilitate integrated network-based electronic reporting and workflow process management related to a Risk Management Coordination System (RMCS) are described below in detail. A technical effect of the systems and processes described herein include at least one of facilitating an electronic submission of information using a client system, automating extraction of information, and web-based reporting for internal and external system users. The RMCS allows a business engaging in complex deals, such as commercial financing, mergers, acquisitions and real estate transactions, to collect, manage, store and disseminate risk management (RM) information among internal deal teams and selected outside deal teams to facilitate a more accurate and efficient analysis of the risks associated with a deal and to facilitate management of workload and personnel. The RMCS also allows a business engaging in complex deals to manage customer relationships, manage specific legal information, manage and create an electronic deal file, manage and create an electronic account manager journal, train personnel, and provide predictive measures based on history, industry trends and economic data.

The RMCS also allows a business engaging in complex deals to generate a plurality of financial scenarios for a customer involved in a deal, and then compare the financial scenario numbers with actual financial numbers for the customer at some point in the future after the deal has been closed. For example, a financing business may project an expected financial scenario for a customer at the time a deal is being underwritten. After a deal closes, the financing business may then utilize the RMCS to compare actual financial numbers for the customer at any point in the future to the expected financial scenario. By making this comparison, the financing business can calculate a variance between the expected scenario and actual. The financing business can also evaluate and revise its underwriting processes based on such comparisons.

In addition, the RMCS allows a financing business to monitor each account or deal after closing. RMCS prompts a deal team member to enter at least one key risk factor, which includes at least one of a key driver, a tracking source, a tracking frequency, a target metric, a trigger level, an impact of factor, and corresponding actions required for each account included within RMCS. The RMCS then monitors these key drivers for each account, and automatically notifies the deal team and management for the financing business if a trigger level for one of the monitored key drivers has been satisfied. The financing business can then determine whether a different account management strategy is required for the account. In particular, the strategy may include updating a Buy/Hold/Sell plan which may include target prices at which a Buy or Sell is approved. The RMCS also allows a user to update the at least one key risk factor, including, but not limited to, the corresponding action plan, during the life of the financing.

In the example embodiment, the RMCS collects, tracks, displays, and disseminates real time Risk Management (RM) information, which is information relating to a business entity being analyzed (“Analyzed Business”) by another business engaging in complex deals, such as commercial financing, mergers, acquisitions and real estate transactions (“Commercial Finance Business” or “CF Business”). RM information includes at least one of business information, accounts payable, accounts receivable, covenant compliance, financial statements, capital structure, income statements, inventory, leverage, loan profile, collateral, guarantors, machinery and equipment, real estate, liquidation value, and other documents and information relating to the financial condition of the Analyzed Business.

The RMCS enables the CF Business to input RM information on a single occasion and into a single computer workstation that may be located at various locations. In addition, the RMCS permits the various internal deal teams within the CF Business to share RM information when conducting a due diligence analysis and to continue account management on the Analyzed Business. The RMCS also enables the CF Business to provide RM information to outside deal teams, like outside legal counsel, during the due diligence analysis. The RMCS also enables a user to monitor a plurality of accounts included in a portfolio, and monitor a plurality of portfolios. Additionally, the RMCS enables a deal team leader to manage a workload of an account manager as well as enabling a senior risk officer to manage a workload of deal team leaders. The RMCS further permits the CF Business to devote more time to analyzing RM information and conducting a due diligence analysis, and less time entering, checking and reporting data.

RM information relating to the Analyzed Business is received by the RMCS which stores the RM information in a database, updates the database with RM information received, tracks the RM information received, provides RM information in response to an inquiry, allows selected outside deal teams to review and comment on RM information, and provides a report to at least one managerial user within the CF Business summarizing the review of RM information for an Analyzed Business.

In the RMCS, RM information is stored in the database. The network based RMCS provides convenient access to RM information, including at least one of business information, accounts payable, accounts receivable, availability analysis, covenant compliance, coverage ratios, financial statements, financial statement and availability projections, capital structure, income statements, inventory, leverage, loan profile, collateral, guarantors, machinery and equipment, real estate, liquidation value, amortization, capital raising history, equity valuation, and other documents and information relating to the financial condition of the Analyzed Business. A user must be authorized to gain access into the RMCS. In the example embodiment, once the RMCS home page is accessed, the user will be able to choose from a list of Analyzed Businesses, also known as accounts, for which the user is responsible, is listed on the deal team, or has been granted access by other users. Once the user selects the account to be reviewed, the user can review RM information relating to the Analyzed Business associated with that account. In an example embodiment, only an authorized user can access the RM information. In addition, the example embodiment enables a user to monitor and view RM information for a plurality of accounts which comprise a portfolio.

In one embodiment, the system is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

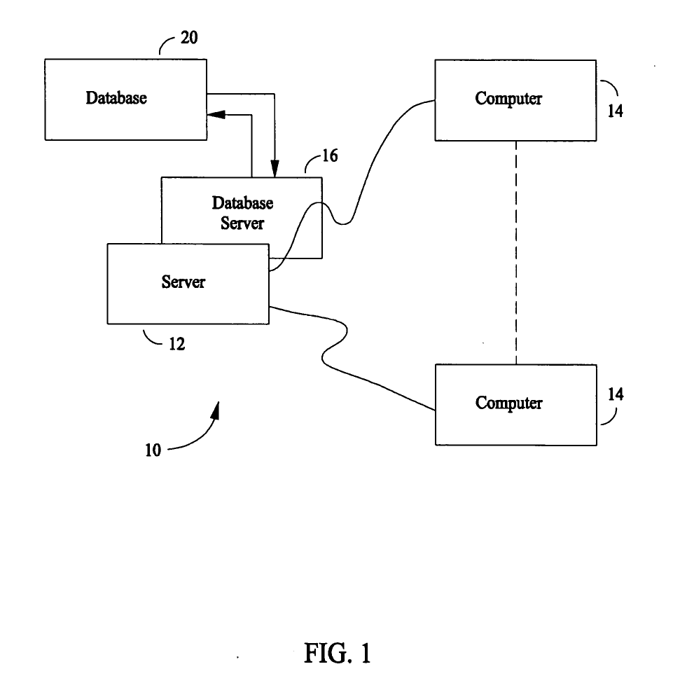

FIG. 1 is a simplified block diagram of a Risk Management Coordination System (RMCS) 10 including a server system 12, and a plurality of client sub-systems, also referred to as client systems 14, connected to server system 12. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment database 20 is stored remotely from server system 12 and may be non-centralized.

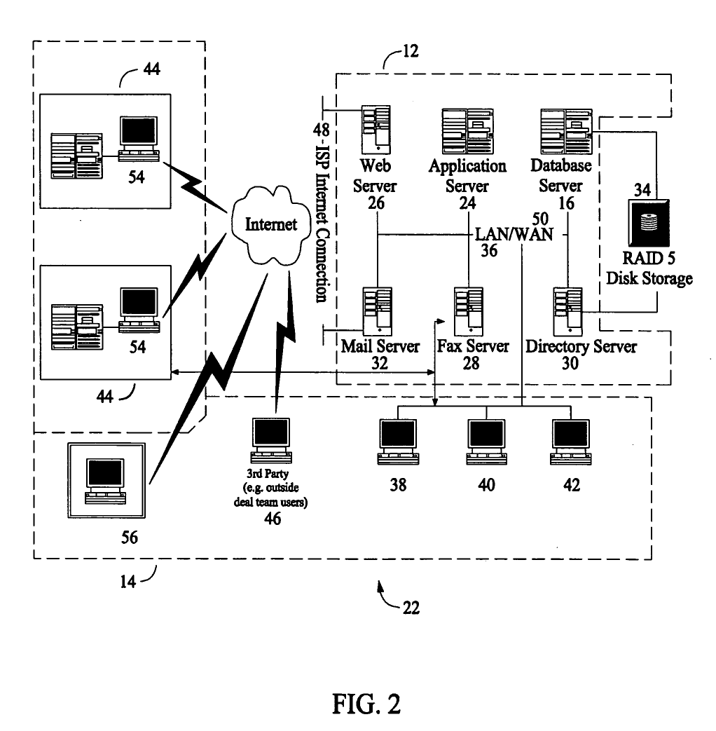

FIG. 2 is an expanded version block diagram of an example embodiment of a server architecture of a RMCS 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36. In an example embodiment, client system 14 includes workstation 40 which can be used by an internal deal team user or a designated outside deal team user to review RM information relating to an Analyzed Business.

Server system 12 is configured to be communicatively coupled to various individuals, including employees 44 and third parties, e.g., designated outside deal team users, 46 via an ISP Internet connection 48. The communication in the example embodiment is illustrated as being performed via the Internet, however, any other wide area network (WAN) type communication can be utilized in other embodiments, i.e., the systems and processes are not limited to being practiced via the Internet. In addition, and rather than WAN 50, local area network 36 could be used in place of WAN 50.

In the example embodiment, any authorized individual having a workstation 54 can access RMCS 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 via a telephone link. Fax server 28 is configured to communicate with other client systems 38, 40, and 42 as well.

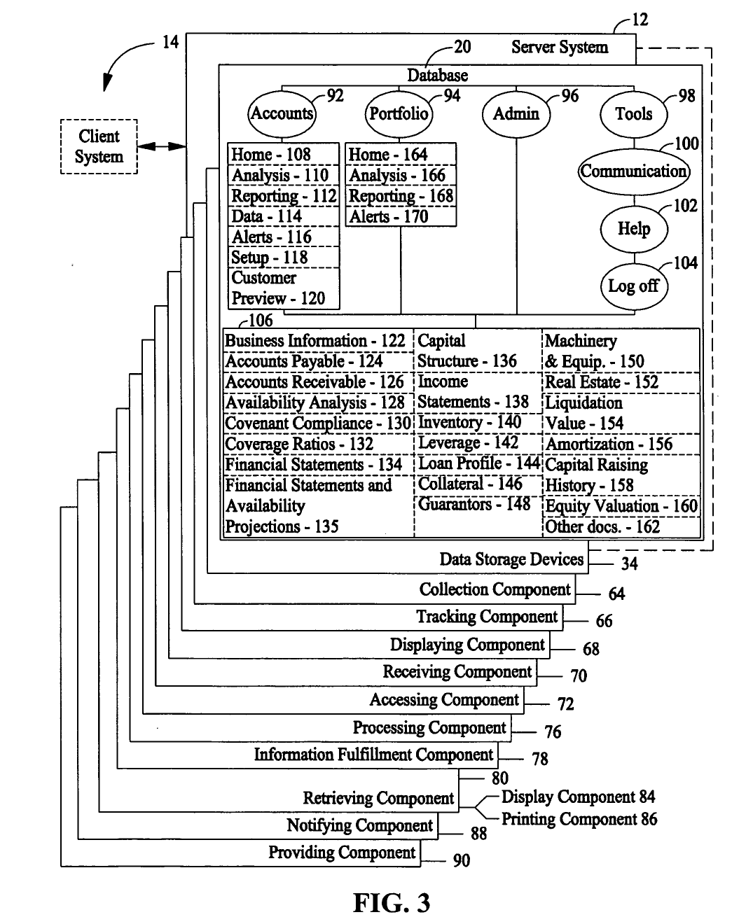

FIG. 3 shows a configuration of database 20 within database server 16 of server system 12 shown in FIG. 1. Database 20 is coupled to several separate computer software components within server system 12, which perform specific tasks. In the example embodiment, server system 12 includes a collection component 64 for collecting data from users in database 20, a tracking component 66 for tracking data, and a displaying component 68 to display information. Tracking component 66 tracks and cross-references data, including modifying existing data.

Server system 12 also includes a receiving component 70 to receive a specific query from client system 14, and an accessing component 72 to access data within data storage device 34. Receiving component 70 is programmed to receive a query from one of a plurality of users. Server system 12 further includes a processing component 76 for searching and processing received queries against database 20 containing a variety of information collected by collection component 64. An information fulfillment component 78 located in server system 12 enables the requested information to be downloaded to the plurality of users in response to the requests received by receiving component 70. Information fulfillment component 78 downloads the information after the information is retrieved from database 20 by a retrieving component 80. Retrieving component 80 retrieves, downloads and sends information to client system 14 based on a query received from client system 14.

Retrieving component 80 also includes a display component 84 that is configured to download information to be displayed on a client system's graphical user interface, and a printing component 86 that is configured to print information. Retrieving component 80 generates reports requested by the user through client system 14 in a pre-determined format. System 10 is flexible to provide other alternative types of reports and is not constrained to the options set forth above.

Server system 12 also includes a notifying component 88 and a providing component 90. Notifying component 88 electronically transmits a message to client system 14 based on information inputted into server system 12, notifying a user of the status of the review of RM information by the deal team. Providing component 90 electronically provides a report to manager workstation 56 (shown in FIG. 2) summarizing the review of the RM information by the deal team, including the deal team's findings and recommendations relating to whether the CF Business should take risk mitigation action with respect to the deal, and, if so, what type of action is recommended.

In one embodiment, collection component 64, tracking component 66, displaying component 68, receiving component 70, processing component 76, information fulfillment component 78, retrieving component 80, display component 84, printing component 86, notifying component 88, and providing component 90 are computer programs embodied on computer readable medium.

Database 20 is divided into an Accounts Section 92, a Portfolio Section 94, an Admin Section 96, a Tools Section 98, a Communication Section 100, a Help Section 102, and a Logoff Section 104. Accounts Section 92 illustrates RM information 106 for each individual account, which are also known as the Analyzed Businesses, within RMCS 10 (shown in FIG. 1). To facilitate searching within database 20, Accounts Section 92 is sub-divided into a Home Section 108, an Analysis Section 110, a Reporting Section 112, a Data Section 114, an Alerts Section 116, a Setup Section 118, and a Customer Preview Section 120.

RM information 106 includes at least one of the following for each Analyzed Business: business information 122, accounts payable 124, accounts receivable 126, availability analysis 128, covenant compliance 130, coverage ratios 132, financial statements 134, financial statement and availability projections 135, a capital structure 136, income statements 138, inventory 140, leverage 142, a loan profile 144, collateral 146, guarantors 148, machinery and equipment 150, real estate 152, a liquidation value 154, amortization 156, a capital raising history 158, an equity valuation 160, and other documents and information 162 relating to the financial condition of the Analyzed Business.

Portfolio Section 94 illustrates RM information 106 on an aggregate basis for a plurality of accounts (or Analyzed Businesses) within a portfolio and inputted in RMCS 10. To facilitate searching, Portfolio Section 94 is sub-divided into a Home Section 164, an Analysis Section 166, a Reporting Section 168, and an Alerts Section 170.

Admin Section 96 enables the user to access RM information 106, and delegate accounts to various other users, including internal deal team users and outside deal team users.

Tools Section 98 enables the user to access RM information 106 and provides a user with links to other commercial finance resources.

Communication Section 100 enables the user to access RM information 106 and provides useful links to historical and current communications (e.g., e-mails, correspondence, memos, etc.) from users within the CF Business.

Help Section 102 displays additional information links relating to RMCS 10 (shown in FIG. 1). In the example embodiment, Help Section 102 includes a user guide link, a glossary of defined terms link, a frequently asked questions link, a quick reference card link, and a feedback link.

Logoff Section 104 permits a user to logoff of RMCS 10 (shown in FIG. 1).

System 10 accumulates a variety of confidential data and has different access levels to control and monitor the security of and access to system 10. Authorization for access is assigned by system administrators on a need to know basis. In one embodiment, access is provided based on job functions. In yet another embodiment, system 10 provides access based on a business-entity. The administration/editing capabilities within system 10 are also restricted to ensure that only authorized individuals have access to modify or edit the data existing in the system. System 10 manages and controls access to system data and information.

The architectures of system 10 as well as various components of system 10 are exemplary only. Other architectures are possible and can be utilized in connection with practicing the processes described below.

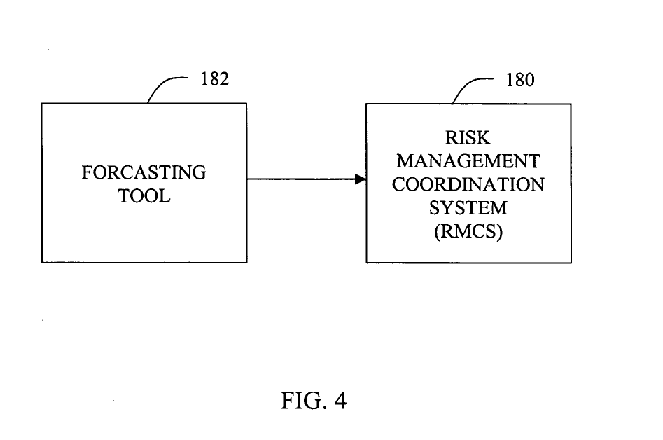

FIG. 4 is a block diagram of a Risk Management Coordination System (RMCS) 180 in communication with a cash flow forecasting tool 182. In the example embodiment, cash flow forecasting tool 182 may include a commercially available forecasting tool such as Alcar®. Alcar® is a computer software application that enables a user to project or model a financial situation of a business entity based on actual, historical financial information for the business entity. (Alcar is a registered trademark of The Alcar Group Inc., Skokie, Ill. 60077.)

During the underwriting process, a deal team will gather RM information including historical financial data relating to a customer involved in a potential deal. This financial data is entered into forecasting tool 182 such that a variety of scenarios can be run to project how the customer might perform in the future if the deal were approved and completed. Once the deal team agrees on an “expected” scenario for the customer, the deal team must determine whether the proposed deal is the type of deal that the CF Business would be interested in participating in. If so, the deal team will submit an approval request to management of the CF Business.

The underwriting process, including tasks to be performed, timelines for performing those tasks, and the persons responsible for performing those tasks, may be managed by a workflow system. In the example embodiment, a workflow system may be a system as described in U.S. Pat. No. 6,618,730 assigned to GE Capital Commercial Finance, Inc., Stamford, Conn. This workflow system notifies responsible persons of pending deadlines and tasks concerning a particular deal. The workflow system may prompt the deal team to submit the approval request to management of the CF Business.

In the example embodiment, immediately following the submission of the approval request, the deal team is prompted to enter and archive all financial scenarios included within the approval request in forecasting tool 182. In addition, financial scenarios may also have to be submitted and archived within forecasting tool 182 for certain amendments, modifications and waivers to a deal. In the example embodiment, these scenarios are generated and archived using an Audit Point Archive function within Alcar®.

After a deal is closed, data included within forecasting tool 182 including financial scenarios are communicated from forecasting tool 182 to RMCS 180. In the example embodiment, the first expected case scenario received in RMCS 180 is assigned a label of “Original Expected Case”. In certain circumstances, an expected case scenario must be updated. Those circumstances include at least one of: 1) material acquisition; 2) material divestiture or 3) recapitalization or refinance. In such cases, the new expected case scenario must be exported to RMCS 180 from forecasting tool 182 after the material acquisition, material divestiture, recapitalization or refinance has closed. The new expected case will be stored in RMCS 180 and labeled with a date/time stamp.

The expected financial scenario for the customer is then stored in RMCS 180. Even after the deal is closed, the CF Business continues to monitor the financial performance of the customer since the CF Business has a financial interest in the customer. Accordingly, RMCS 180 is configured to monitor the financial performance of the customer including comparing the expected financial scenario with actual financial numbers for the customer. The CF Business can perform this comparison at any time in the future. RMCS 180 can generate a plurality of metrics showing the comparison between the expected scenario and the actual financial numbers including an EBITDA percentage.

By comparing the expected financial scenario with actual financial numbers for the customer, the CF Business can evaluate its underwriting process and can determine whether changes need to be made to its current underwriting process.

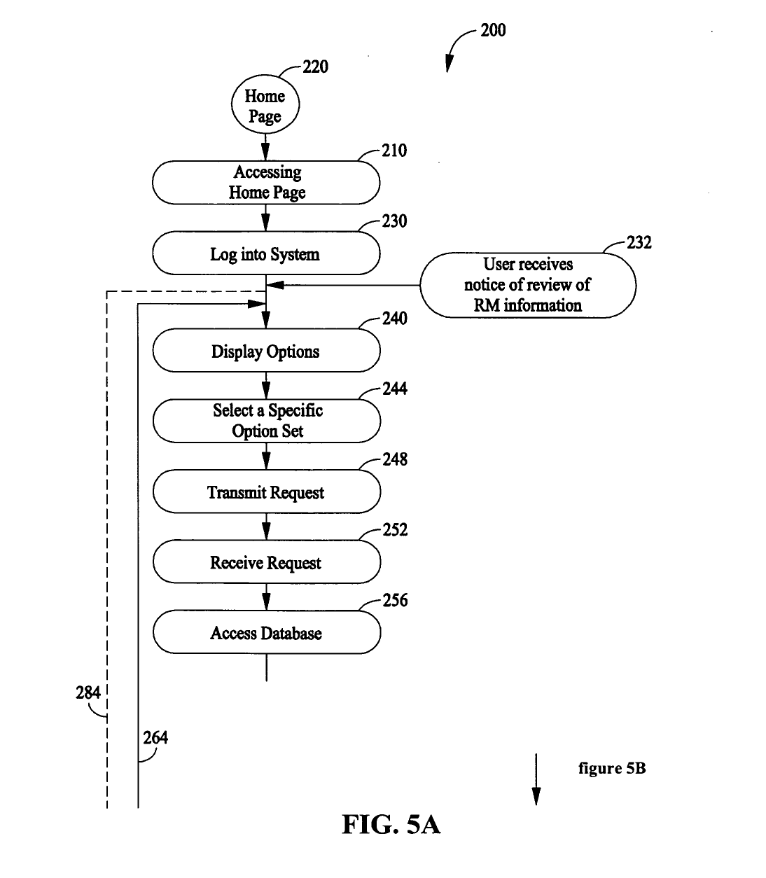

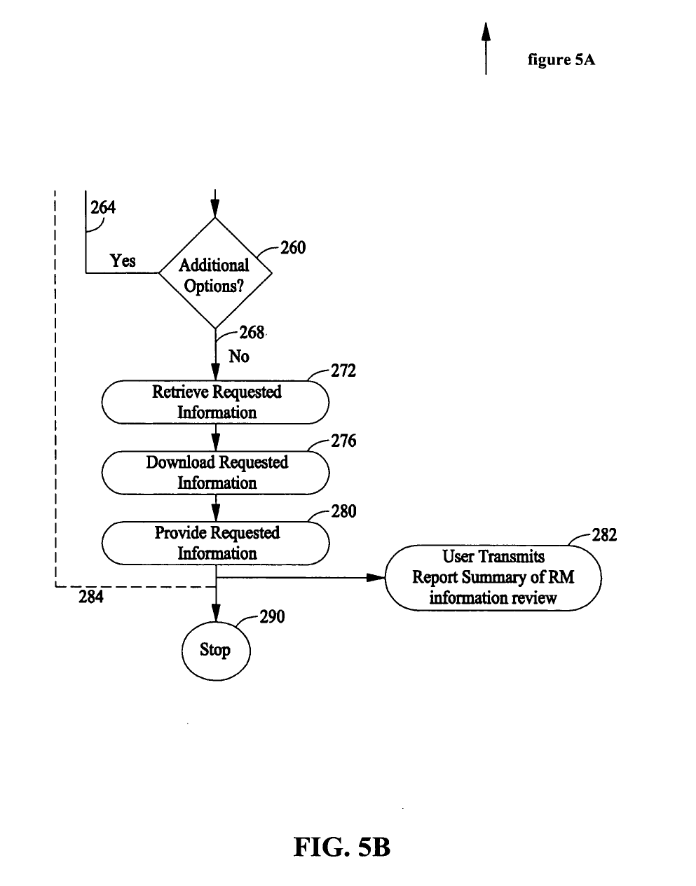

FIGS. 5A and 5B show a flowchart 200 illustrating example processes utilized by system 10. The technical effect of RMCS 10 is achieved by a user first accessing 210 a user interface, such as a home page 220, of the web site through client system 14 (shown in FIG. 1). In one embodiment, client system 14, as well as server system 12, are protected from access by unauthorized individuals. The user logs-in 230 to system 10 using a password (not shown) and an employee user login for security. The technical effect is further achieved through client system 14, which is configured to receive 232 an electronic notice indicating that a review of RM information 106 (shown in FIG. 3) has occurred, and whether any comments or findings were made relating to the review.

Client system 14 also displays 240 options available to the user through links, check boxes, or pull-down lists. Once the user selects 244 an option (in one embodiment, relating to a facility within the business entity) from the available links, the request is transmitted 248 to server system 12. Transmitting 248 the request is accomplished, in one embodiment, either by click of a mouse or by a voice command. Once server system 12 (shown in FIG. 1) receives 252 the request, server system 12 accesses 256 database 20 (shown in FIG. 1). System 10 determines 260 if additional narrowing options are available. In one embodiment, additional narrowing options relate to at least one of the Analyzed Business and RM information 106, and include check boxes, hyperlinks, buttons, and pull-down lists. If additional narrowing options are available 264, system 10 displays 240 the options relating to the prior option selected by the user on client system 14. The user selects 244 the desired option and transmits the request 248. Server system 12 receives the request 252 and accesses 256 database 20. When system 10 determines that additional options 260 are not available 268, system 10 retrieves 272 requested information from database 20. The requested information is downloaded 276 and provided 280 to client system 14 from server 12. Client system 14 transmits a report 282 from a user to manager workstation 56 (shown in FIG. 2) summarizing the review of RM information 106 by a deal team, including the deal team's comments and findings. The user can continue to search 284 database 20 for other information or exit 290 from system 10.

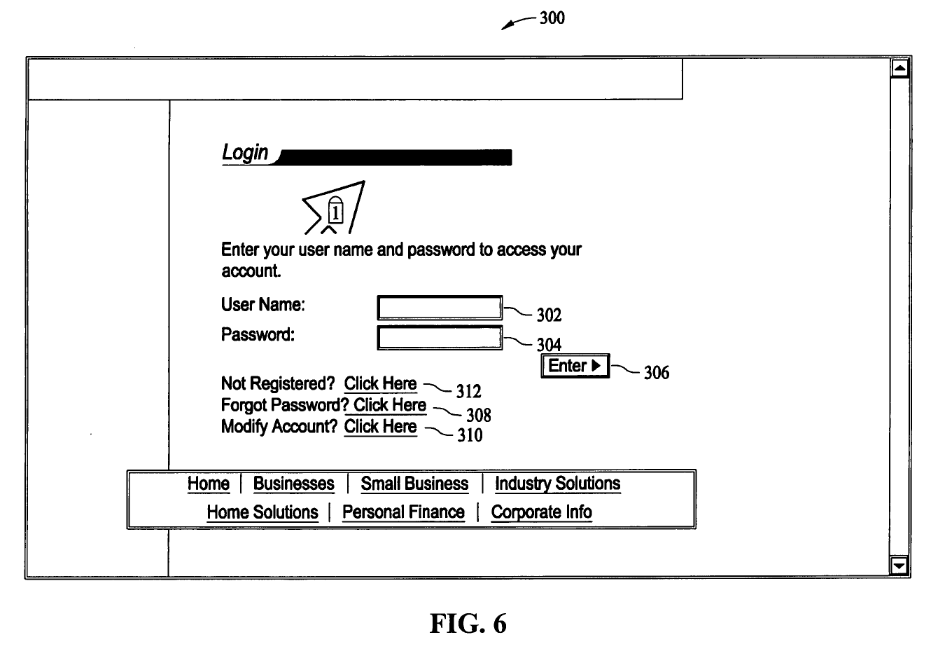

FIG. 6 is an example embodiment of a user interface 300 displaying a login page included within RMCS 10 (shown in FIG. 1). User interface 300 illustrates a User Name field 302 and a Password field 304. All users must have a user name and password to log-on to RMCS 10. In an example embodiment, user interface 300 also shows an “Enter” button 306, which the user must select after entering an appropriate user name in User Name field 302 and password in Password field 304. Although buttons are shown in the example embodiment, pull-down lists, check boxes, and other means for inputting this information could also be used. User interface 300 is the entry point for anyone trying to access RMCS 10 and database 20 (shown in FIG. 1) via the web. After entering the requested information and selecting Enter button 306, the user enters RMCS 10.

User interface 300 also displays hyperlinks Forgot Password 308, Modify Account 310, and Not Registered 312. By selecting Forgot Password 308 hyperlink, a screen is displayed prompting the user to input information. By inputting the requested information, RMCS 10 provides the user with their assigned password. Similarly, by selecting Modify Account 310 hyperlink, a user is prompted by a screen to input information that will change the user's current password.

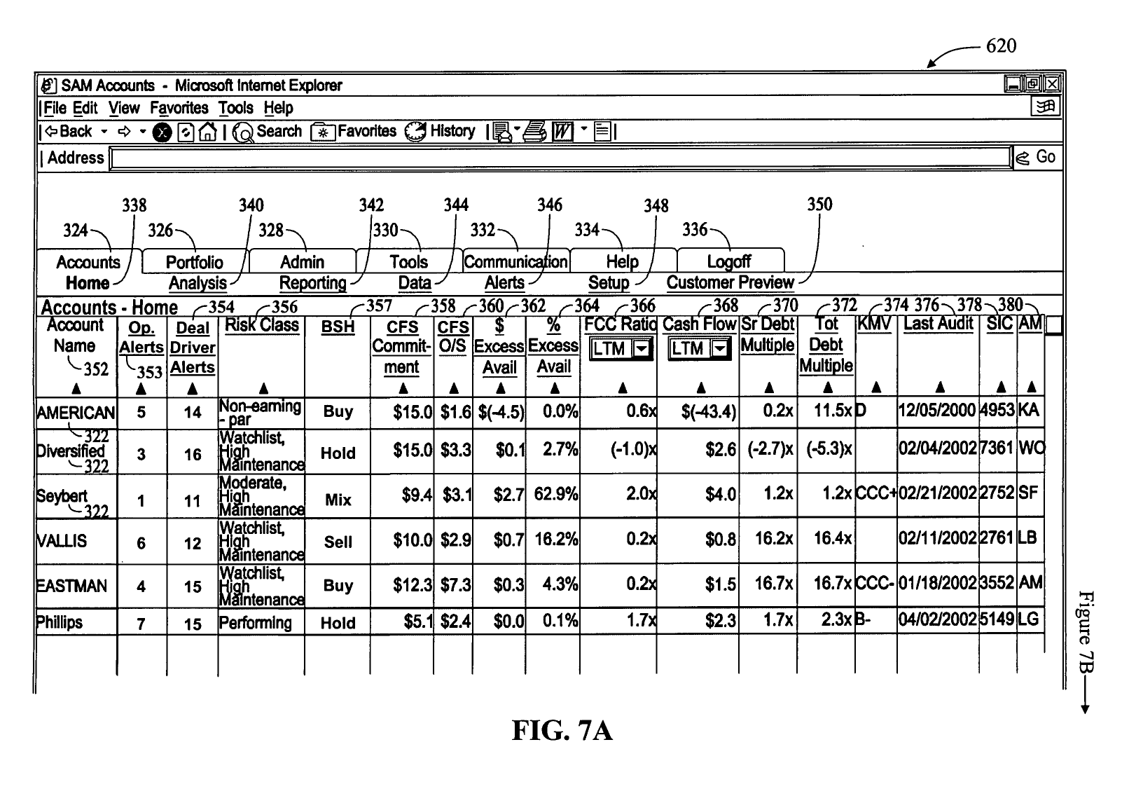

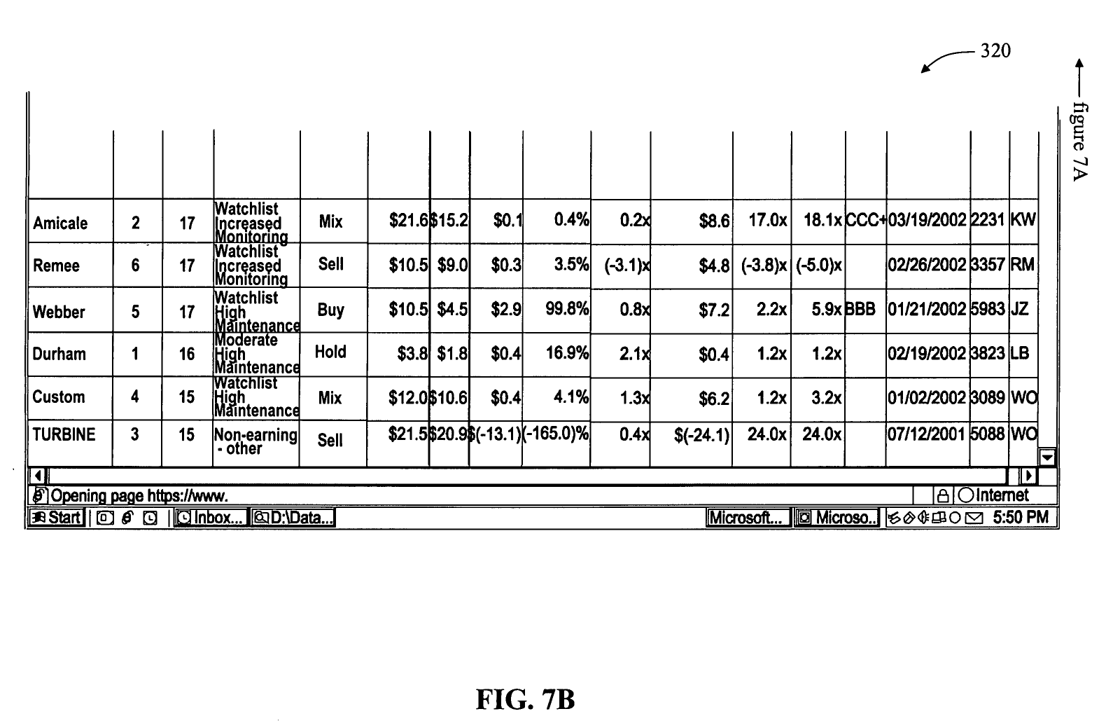

FIGS. 7A and 7B show an example embodiment of a user interface 320 displaying a home page included within RMCS 10 (shown in FIG. 1), which is displayed after a user has logged onto RMCS 10. User interface 320 displays a summary of RM information 106 (shown in FIG. 3) for all accounts 322, or Analyzed Businesses, for which the user is responsible, is listed on a deal team, or has been assigned to by other users. In an example embodiment, user interface 320 illustrates a plurality of menu tabs including at least one of Accounts 324, Portfolio 326, Admin 328, Tools 330, Communication 332, Help 334, and Logoff 336. Although tabs are shown in the example embodiment, pull-down lists, check boxes, and other means for inputting this information could also be used. These menu tabs enable the user to navigate RMCS 10.

In the example embodiment, user interface 320 also displays sub-menu tabs located below the menu tabs. The sub-menu tabs include at least one of Home 338, Analysis 340, Reporting 342, Data 344, Alerts 346, Setup 348, and Customer Preview 350. The sub-menu tabs further enable the user to navigate RMCS 10. In the example embodiment, user interface 320 is displayed when Accounts 324 and Home 338 are selected or upon logging into the system.

When menu tab Accounts 324 and sub-menu tab Home 338 are selected, user interface 320 displays a summary of RM information 106 in tabular form for each accounts 322 for which the user is responsible, is listed on a deal team, or has been assigned to by other users. In the example embodiment, the table includes at least the following column headers: Account Name 352, Op. Alerts 353, Deal Driver Alerts 354, Risk Class 356, BSH (Buy/Sell/Hold) Summary 357, Commercial Finance (CF)-Commitment 358, CF Outstandings (CF O/S) 360, $ Excess Avail 362, % Excess Avail 364, Fixed Charge Coverage Over The Last Twelve Months (FCC LTM) 366, Cash Burn LTM 368, Sr. Debt 370, Tot. Debt 372, KMV 374, Last Audit 376, SIC 378, and Account Manager (AM) 380. KMV is a third party credit valuation tool. SIC is a code that identifies an industry that the business operates within. An Account Manager is a person within the CF Business that manages the account and underwrites the original transaction. In the example embodiment, each column is sortable by ascending or descending order. Additionally, each column header is a link, when selected, displays another screen that provides additional information relating to the selected column header.

FCC LTM 366 and Cash Burn LTM 368 also include pull-down boxes that may be selected by the user. In the example embodiment, the options included in these pull-down boxes are LTM (shown in FIG. 6), L9M (Last Nine Months), L6M (Last Six Months), L3M (Last Three Months), and LIM (Last One Month).

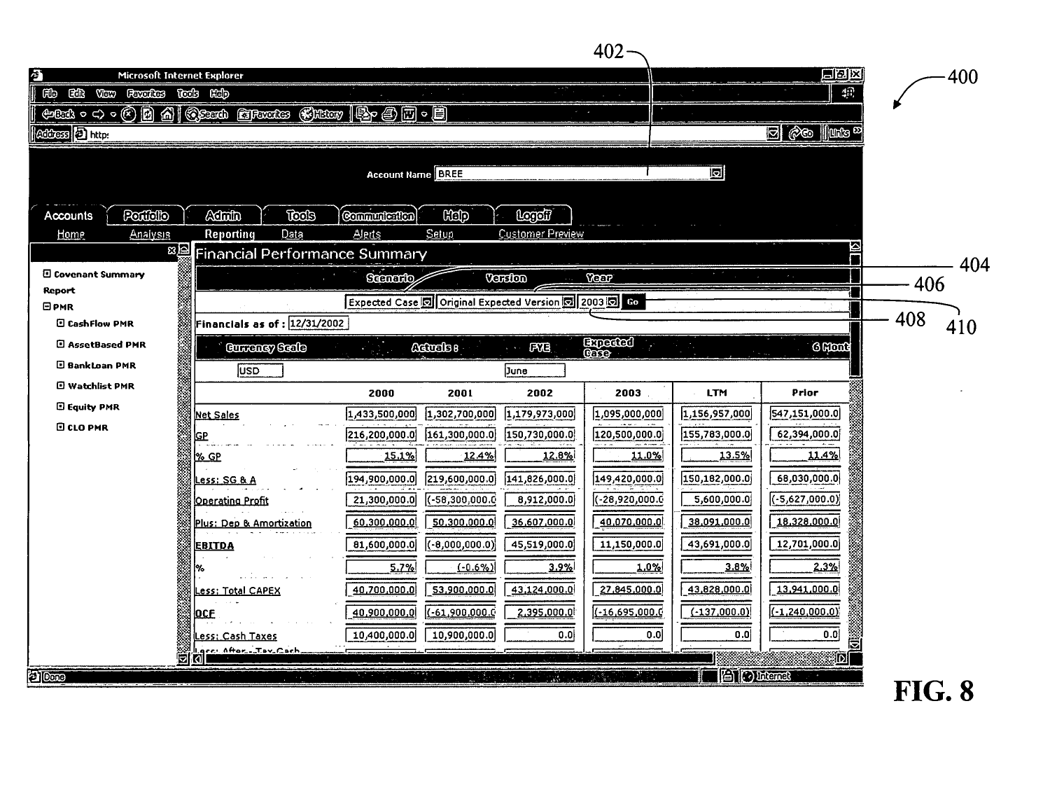

FIG. 8 is an example embodiment of a user interface 400 displaying a financial performance summary page included within RMCS 10 (shown in FIG. 1). User interface 400 enables a user to display actual financial data for a specific account, also known as an Analyzed Business, for a selected number of years along side projected financial data for an Expected Case scenario for the same account.

User interface 400 allows the financing business to store an Expected Case financial scenario at the time the deal is underwritten. This Expected Case financial scenario is sometimes referred to as the Original Expected Version since it is generated at the time the deal is initially underwritten. The CF Business can then compare this Original Version Expected Case scenario with future actual financial data. By making this comparison, the CF Business can calculate a variance between the Original Version Expected Case scenario and the actual financial data. The CF Business can then evaluate the method in which it calculated the Original Version Expected Case scenario and make any adjustments to that method as determined from the evaluation. Moreover, the CF Business can also evaluate its underwriting process to determine whether the information it used in calculating the Original Version Expected Case scenario was accurate, and make any changes to its underwriting process as determined from the evaluation.

RMCS 10 also enables a user to generate additional financial scenarios. In other words, at some point after generating an Original Version Expected Case scenario, the CF Business can decide to generate a “revised” expected case scenario. The revised scenario can be stored in RMCS 10 and can be compared to actual financial data as shown above.

In the example embodiment, user interface 400 includes an account name pull-down field 402, a scenario pull-down field 404, a version pull-down field 406, a year pull-down field 408, and a Go button 410. In the example embodiment, user interface 400 displays financial data on a yearly basis including at least one of net sales, gross profit (GP), % of GP, Less SG & A, Operating Profit, Plus Depreciation & Amortization, EBITDA, Less Total CAPEX, Operating Cash Flow (OCF), and Less Cash Taxes. As shown in user interface 400, the financial data shown for years 2000, 2001, and 2002 is actual financial data. The financial data shown for year 2003 is projected financial data using an Expected Case scenario. The Expected Case scenario shown in user interface 400 is the Original Expected Version.

Accordingly, in the example embodiment, user interface 400 displays actual financial data for a specific Analyzed Business for the years 2000, 2001, and 2002. User interface also displays an Expected Case scenario (Original Version) for year 2003 along with financials for a Last Twelve Months (LTM). By so doing, the financing business will be able to compare future actual financial data to the Expected Case scenario stored in RMCS 10.

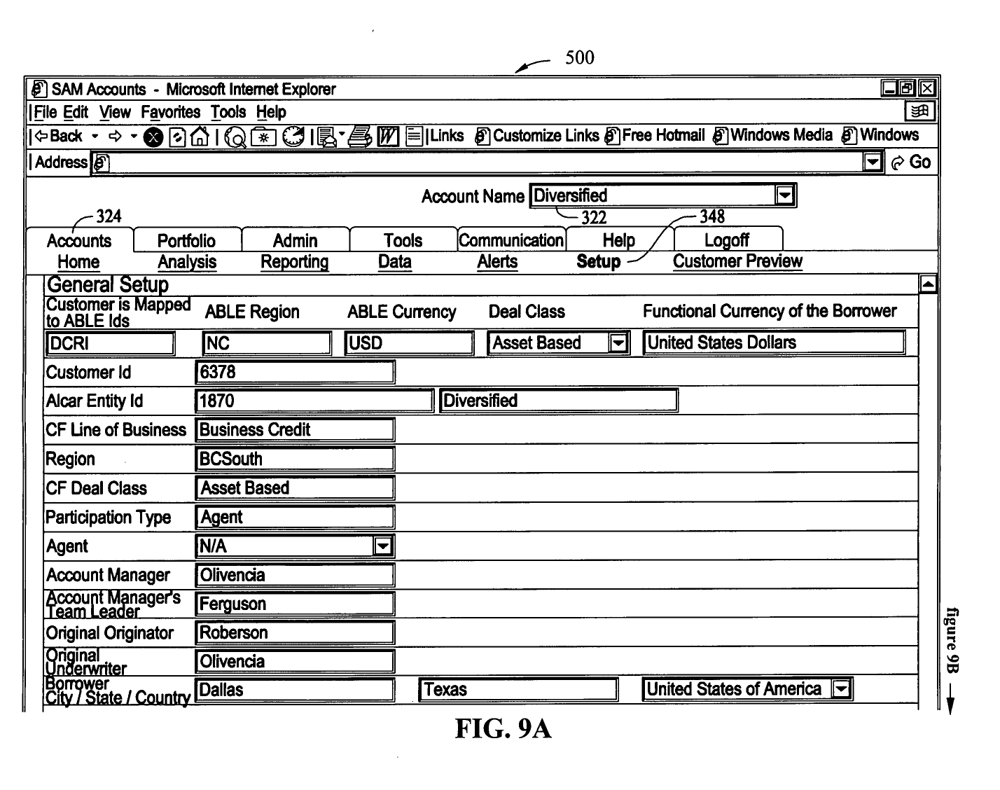

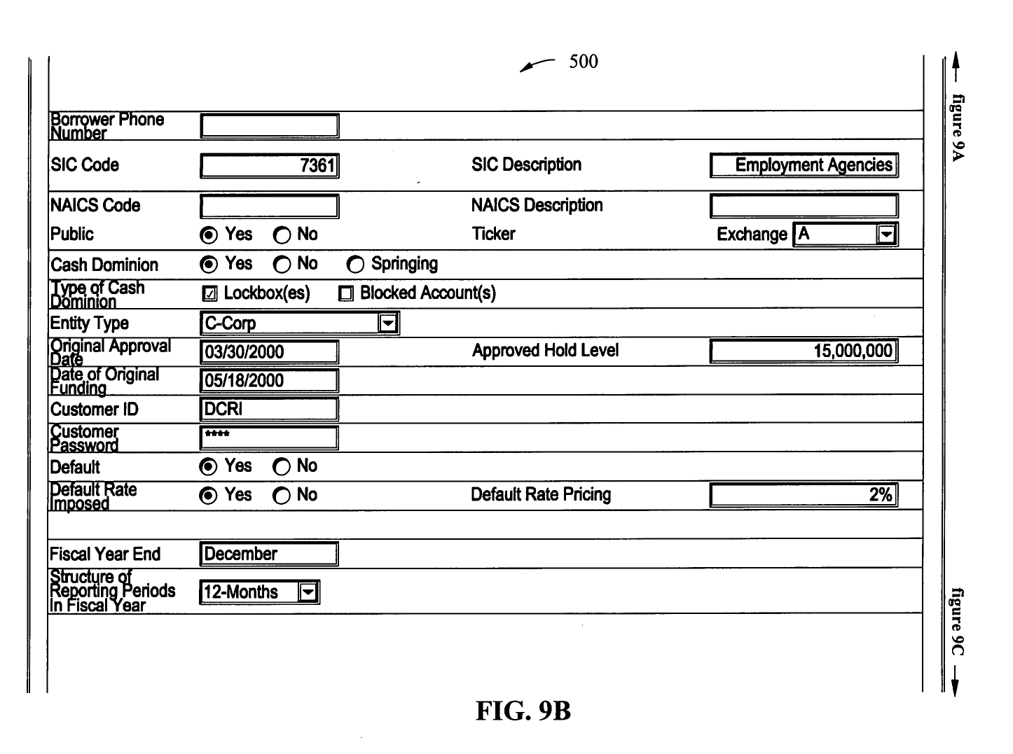

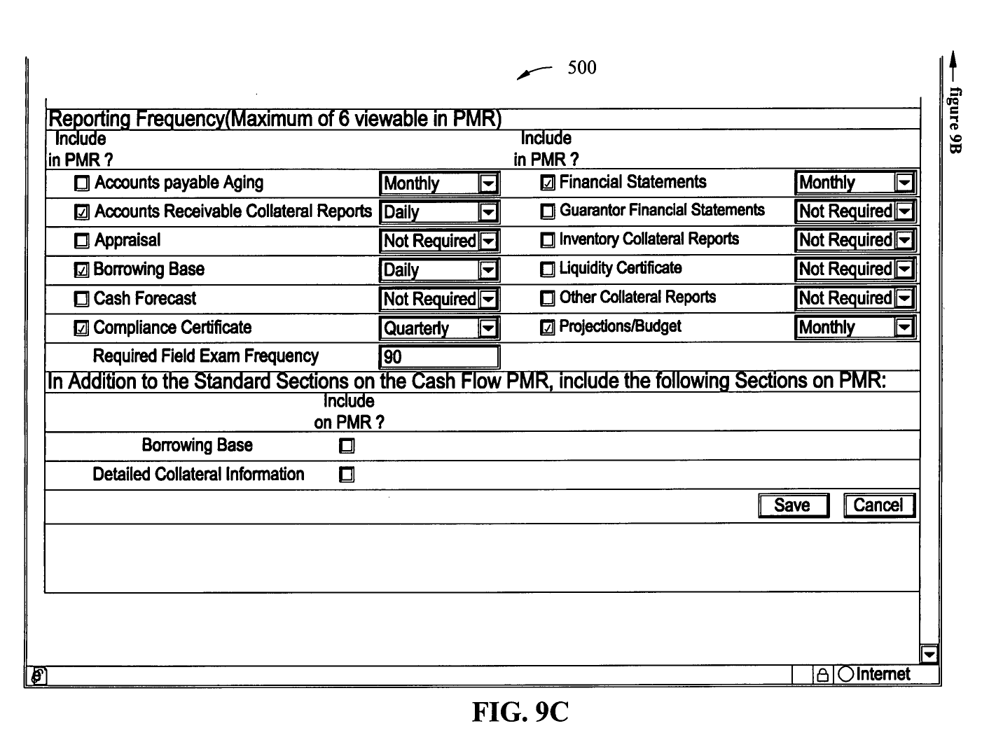

FIGS. 9-13 are example embodiments of user interfaces that prompt the user to input information to setup an account, also known as the Analyzed Business, in RMCS 10 (shown in FIG. 1). In the example embodiment and as explained below, these user interfaces drive numerous calculations and decisions made by RMCS 10.

FIGS. 9A-9C show an example embodiment of user interface 500 displaying a general setup page included within RMCS 10 (shown in FIG. 1). User interface 500 is filled out by a user when starting an account setup process. User interface 500 also displays general information about the account. User interface 500 is displayed after menu tab Accounts 324 and sub-menu tab Setup 348 are selected by a user. User interface 500 also includes a navigation bar (not shown) along the left side of user interface 500 that is common to Setup 348.

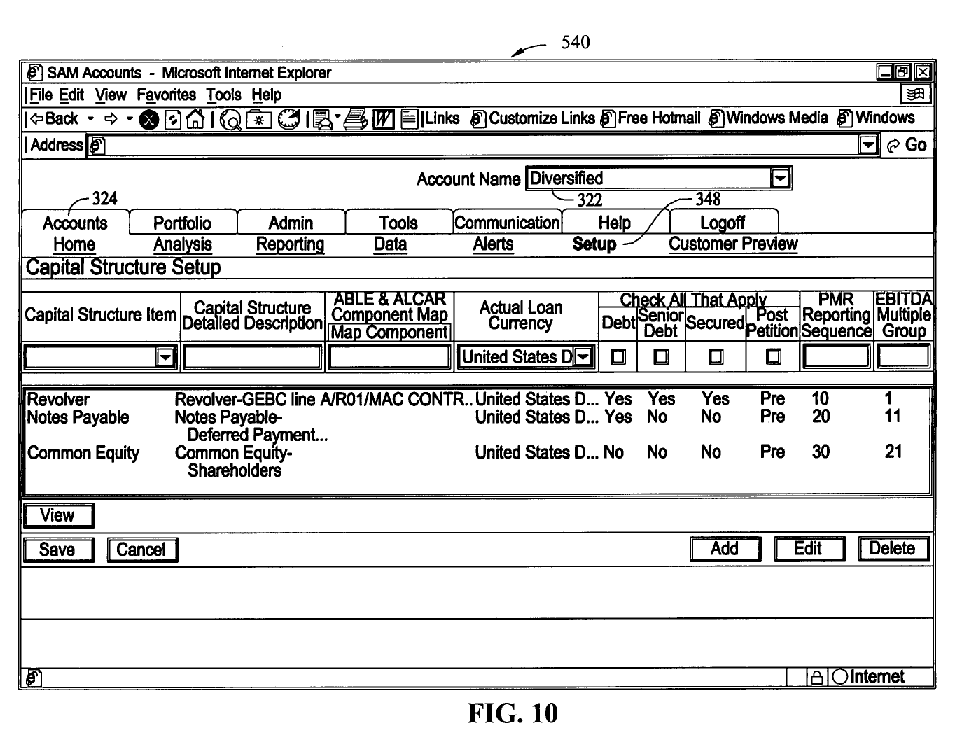

FIG. 10 is an example embodiment of user interface 540 displaying a capital structure setup page included within RMCS 10 (shown in FIG. 1). User interface 540 is for setting up an Analyzed Business's capital structure. User interface 540 is displayed after menu tab Accounts 324 and sub-menu tab Setup 348 are selected by a user. Actual capital structure amounts are input into RMCS 10 (shown in FIG. 1) over time as actual financial results are reported. User interface 540 also includes an ABLE & ALCAR Component Map button that enables a user to map information stored within at least one of ABLE, Alcar®, and RMCS 10. In the example embodiment, after a user clicks the ABLE & ALCAR Component Map button, a pop-up screen is displayed (not shown in FIG. 10) that enables the user to link information stored in at least one of ABLE, Alcar®, and RMCS 10 such that the information may be accessed, displayed, and utilized by RMCS 10.

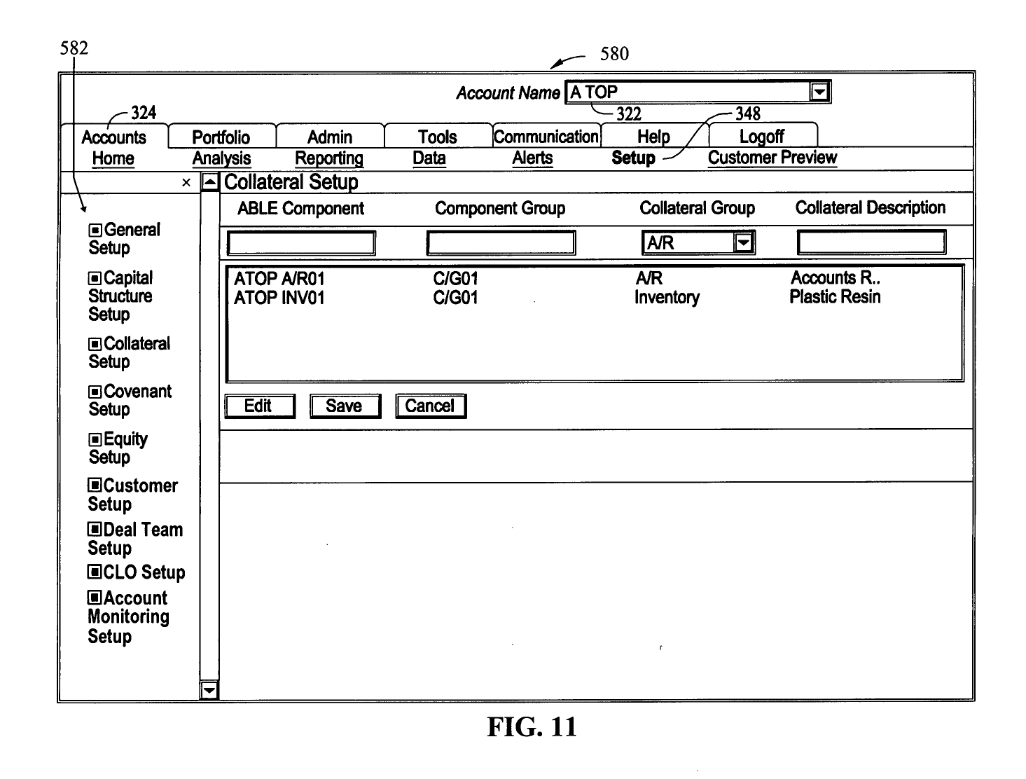

FIG. 11 is an example embodiment of user interface 580 displaying a collateral setup page included within RMCS 10 (shown in FIG. 1). User interface 580 is a screen for setting up an identification of each sub-ledger component by a collateral group. User interface 580 is displayed after menu tab Accounts 324 and sub-menu tab Setup 348 are selected by a user. In the example embodiment, the sub-ledger system shown is ABLE, a known and commercially available software program. Although ABLE is shown in the example embodiment, RMCS 10 does not require ABLE as it sub-ledger system. Rather, RMCS 10 (shown in FIG. 1) can utilize and interface with a plurality of known and commercially available sub-ledger systems.

User interface 580 also displays a navigation bar 582 along the left-side of user interface 580. Navigation bar 582 includes at least the following links: a general setup link, a capital structure setup link, a collateral setup link, a covenant setup link, an equity setup link, a customer setup link, a deal team setup link, a CLO setup link, and an account monitoring setup link. Although not displayed in all of the setup figures included with this application, navigation bar 582 is displayed on most of the setup related user interfaces to better enable a user to navigate these screens.

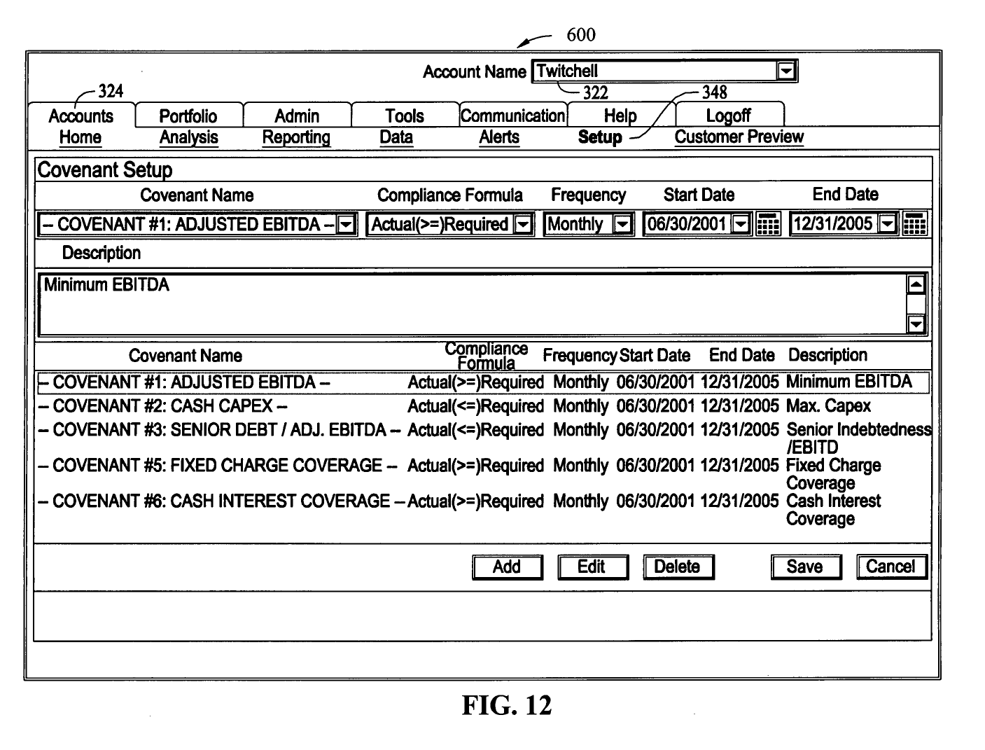

FIG. 12 is an example embodiment of user interface 600 displaying a covenant setup page included within RMCS 10 (shown in FIG. 1). User interface 600 displays covenants for a loan for a selected account 322. User interface 600 is displayed after menu tab Accounts 324 and sub-menu tab Setup 348 are selected by a user. In the example embodiment, all covenants should be setup in RMCS 10 (shown in FIG. 1) during the initial setup process. Actual covenant levels are input into RMCS 10 over time as the actual financial results are reported.

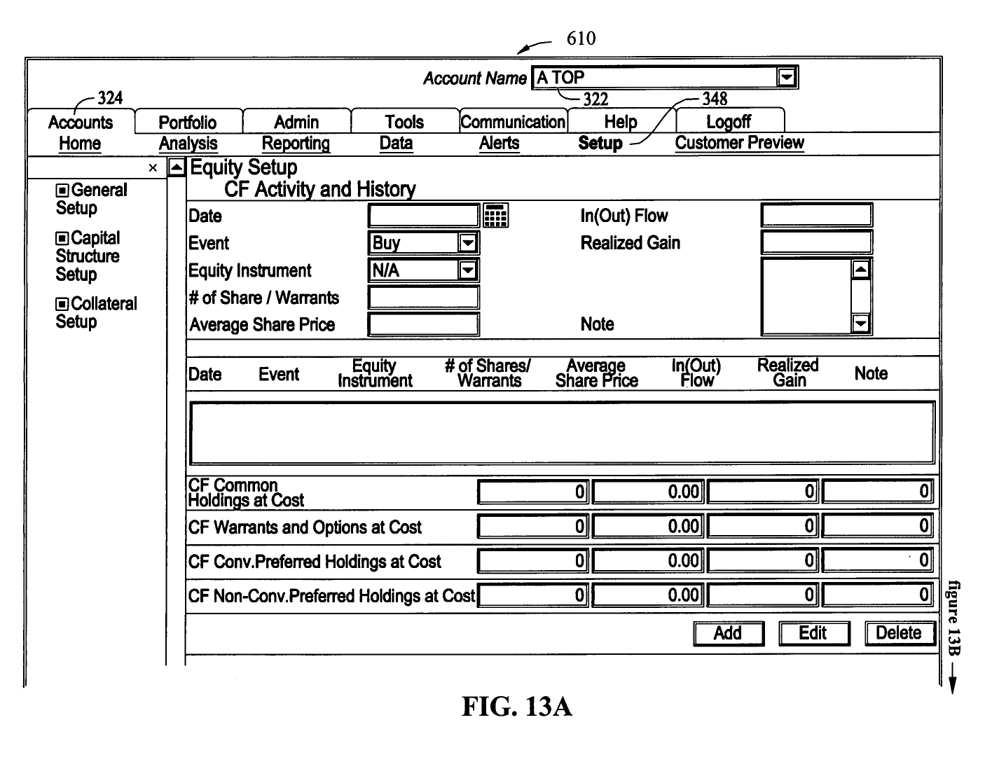

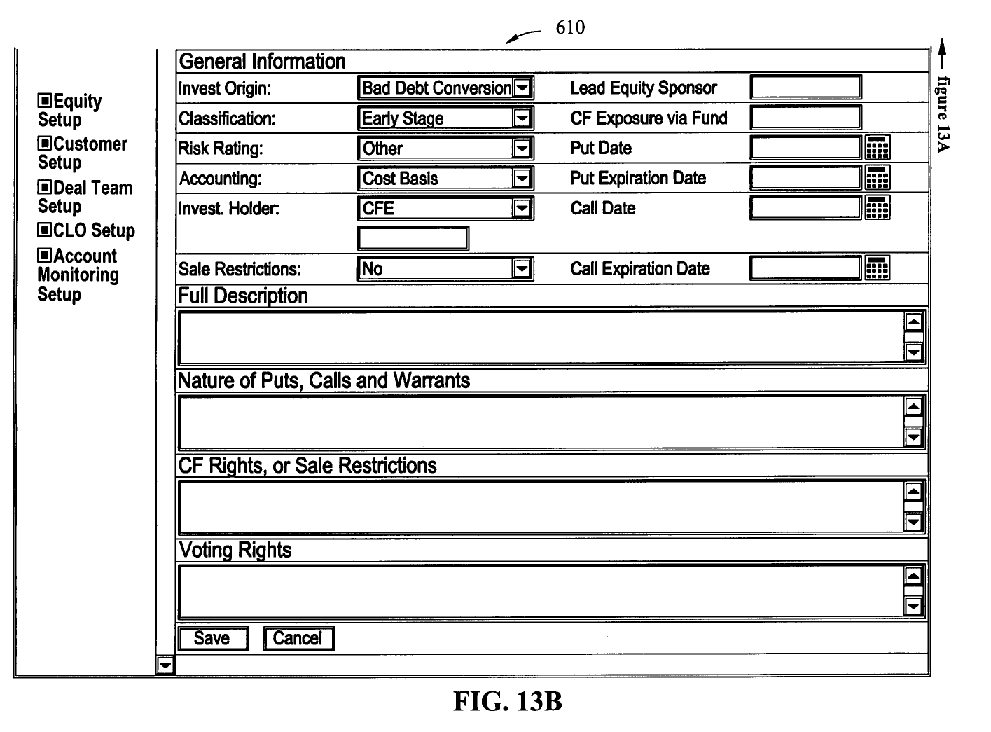

FIGS. 13A-13B show an example embodiment of user interface 610 displaying an equity setup page included within RMCS 10 (shown in FIG. 1). User interface 610 is a screen to be completed for deals involving equity investments for selected account 322. User interface 610 is displayed after menu tab Accounts 324 and sub-menu tab Setup 348 are selected by a user. In the example embodiment, user interface 610 enables a user to track all transactions involving at least one of common stock, non-convertible preferred stock, convertible preferred stock, a Limited Liability Corporation (LLC), a Limited Partnership (LP) interest, warrants, and options. User interface 610 does not have to be completed for equity funds.

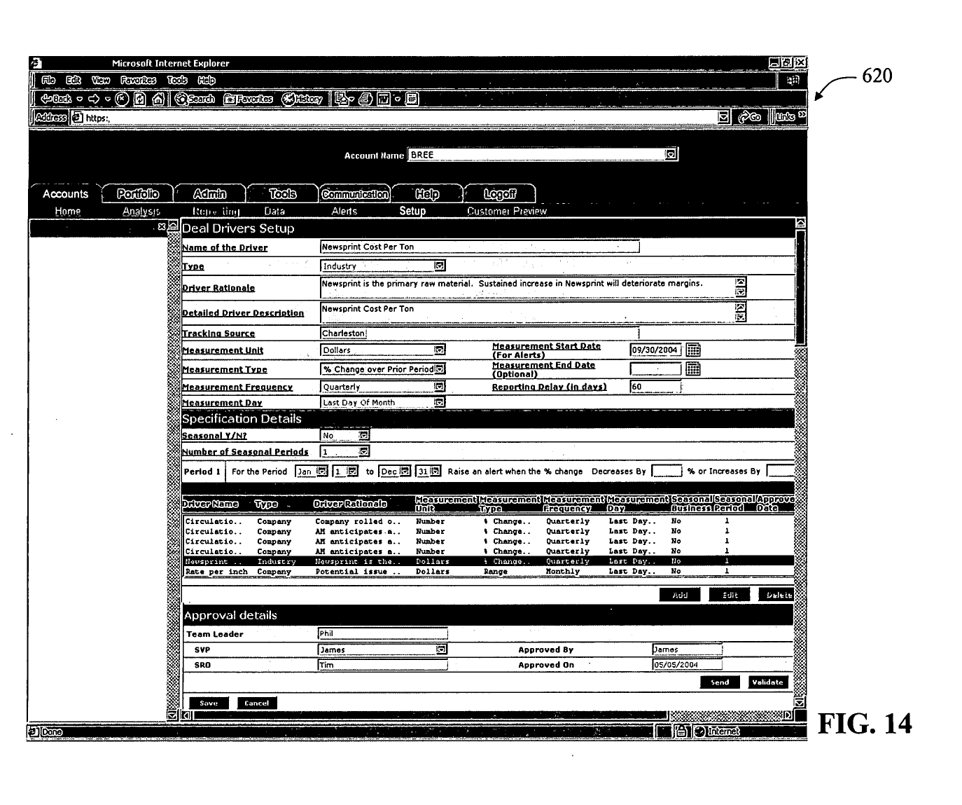

FIG. 14 is an example embodiment of user interface 620 displaying a deal drivers setup page for selected account 322 (shown in FIGS. 13A-13B) in RMCS 10 (shown in FIG. 1). User interface 620 is displayed after menu tab Accounts 324 and sub-menu tab Setup 348 (shown in FIGS. 13A-13B) are selected by a user. In the example embodiment, user interface 620 includes a navigation bar (not shown) having at least the following links: a general setup link, a capital structure setup link, a collateral setup link, a covenant setup link, an equity setup link, a customer setup link, a deal team setup link, a CLO setup link, and an account monitoring setup link. User interface 620 is displayed when the account monitoring setup link is selected.

In the example embodiment, user interface 620 displays for selected account 322 at least the following data: a Name of the Driver data field, a Type pull-down list, a Driver Rationale data field, a Detailed Driver Description data field, a Tracking Source data field, a Measurement Unit pull-down list, a Measurement Type pull-down list, a Measurement Frequency pull-down list, a Measurement Day pull-down list, a Measurement Start Date data field with calendar link, a Measurement End Date data field with calendar link, a Reporting Delay data field, a Specification Details section, a Seasonal Driver pull-down list, a Number of Seasonal Periods pull-down list, a Period Start Date data field, a Period End Date data field, a Raise An Alert When The % Change Decreases By data field, a Raise An Alert When The % Change Increases By data field, an Approval Details section, a Send button, a Validate button, a Save button, and a Cancel button.

In the example embodiment, the Name of Driver is the name of the deal driver identified in a pitch. The Type is a broad category classification including Industry, Company or Customer. For example, an Industry driver might include resin, gas, oil, lumber etc. A Company driver is specific to the borrower's company, and a Customer driver refers to the Borrower's customer. The Driver Rationale is the rationale for using the identified deal driver. The Detailed Driver Description is a specific description of the deal driver and is intended to avoid any questions at to what is to be tracked. The Tracking Source is the source that the account manager will use to track the driver (i.e., Plastic News via the internet www.plasticnews.com). The Measurement Unit is how the measurement will be tracked including at least one of dollars, percent, number, Yes or No. The Measurement Type is the calculation performed on the Measurement Unit.

The Measurement Frequency is the frequency at which the deal driver will be tracked including at least one of daily, weekly, monthly, quarterly, semi-annual or annual. The Measurement Day identifies if there is a specific date when the driver is to be updated. The Measurement Start Date is the date when data will be input and alerts will start. The Measurement End Date is the date when Deal Driver Tracking ends.

In the Specification Details the Seasonal Driver is either Yes or No. Yes is selected if the deal driver is seasonal. This allows the user to set up multiple specifications for seasonal swings. If Yes is selected, an Upper Specification Limit (USL) and a Lower Specification Limit (LSL) “Seasonal Period” for the Number of Seasonal periods is created (not shown). If No is selected, a USL and LSL “Period 1” is created. If there is more than one Specification to be set up for seasonal swings, the user selects a number and the system will set up that Number of Specifications to be populated.

The Approval Details includes a Team Leader (TL) for notice purposes and a Senior Vice President (SVP) that has notice and approval authority. Senior Risk Officer (SRO) will receive alert exception reports monthly. The Send button sends notices and approval e-mail to the TL and SVP. The Validate button is used by the SVP to approve the deal driver.

In the example embodiment, all deal drivers must be approved by a SVP. This includes any additions, edits and deletions. The Team Leader (TL) is populated by the Deal Team Set-up. The SVP is populated by a user pull-down list. The AM, TL and SVP may edit and delete.

The deal driver includes those risk factors that the deal team believes are relevant to a particular deal. More specifically, a deal driver is assigned by a deal team for the CF Business during the underwriting process of the financing of the Analyzed Business. The deal driver is a financial variable that reflects the strength or weakness of the Analyzed Business' business. In other words, a change in the deal driver may significantly impact the strength of the business. The trigger level is assigned to a deal driver by the CF Business during the underwriting process of the financing and is a threshold level. In one embodiment, a trigger level is satisfied when the value of the deal driver equals the trigger level. In another embodiment, a trigger level is satisfied when the value of the deal driver equals or exceeds the trigger level. In another embodiment, a trigger level is satisfied when the value of the deal driver equals or is less than the trigger level.

The deal team monitors the status of the deal by monitoring the listed deal drivers. For example, if a deal team believes that the price of raw materials is a key risk factor for a specific deal (e.g., if the price of a particular raw material rises to a predetermined amount), the deal team will list raw materials as a deal driver and will then monitor the price of the listed raw material. If the price of that raw material reaches the predetermined amount (i.e., trigger level), RMCS 10 automatically notifies management of the CF Business of this occurrence such that the CF Business can evaluate the status of the Analyzed Business and the status of the deal.

In other words, the deal team monitors the status of the deal by monitoring each deal driver associated with a financing provided by the CF Business to the Analyzed Business. The deal team uses a designated tracking source to determine a value for the deal driver in accordance with a tracking frequency. The value of the deal driver from the tracking source is then compared to the corresponding trigger level, and, if the value of the deal driver from the tracking source satisfies the corresponding trigger level, management of the CF Business is automatically notified of this occurrence. The deal driver may also include a corresponding action plan wherein, if the value of the deal driver from the tracking source satisfies the corresponding trigger level, the action plan may be implemented. The action plan may include altering the current account strategy including at least one of providing additional financing to the customer, selling the financing provided to the customer, and maintaining the financing provided to the customer.

In the example embodiment, a user may indicate whether a deal driver is seasonal. For example, in user interface 620, a user may select “Yes” in the Seasonal Driver pull-down field and may indicate a number of Seasonal Periods. Yes is selected if the deal driver is seasonal. This allows the user to set up multiple specifications for seasonal swings. If Yes is selected, an Upper Specification Limit (USL) and a Lower Specification Limit (LSL) “Seasonal Period” for the Number of Seasonal periods is created. If there is more than one Specification to be set up for seasonal swings, the user selects a number and the system will set up that Number of Specifications to be populated.

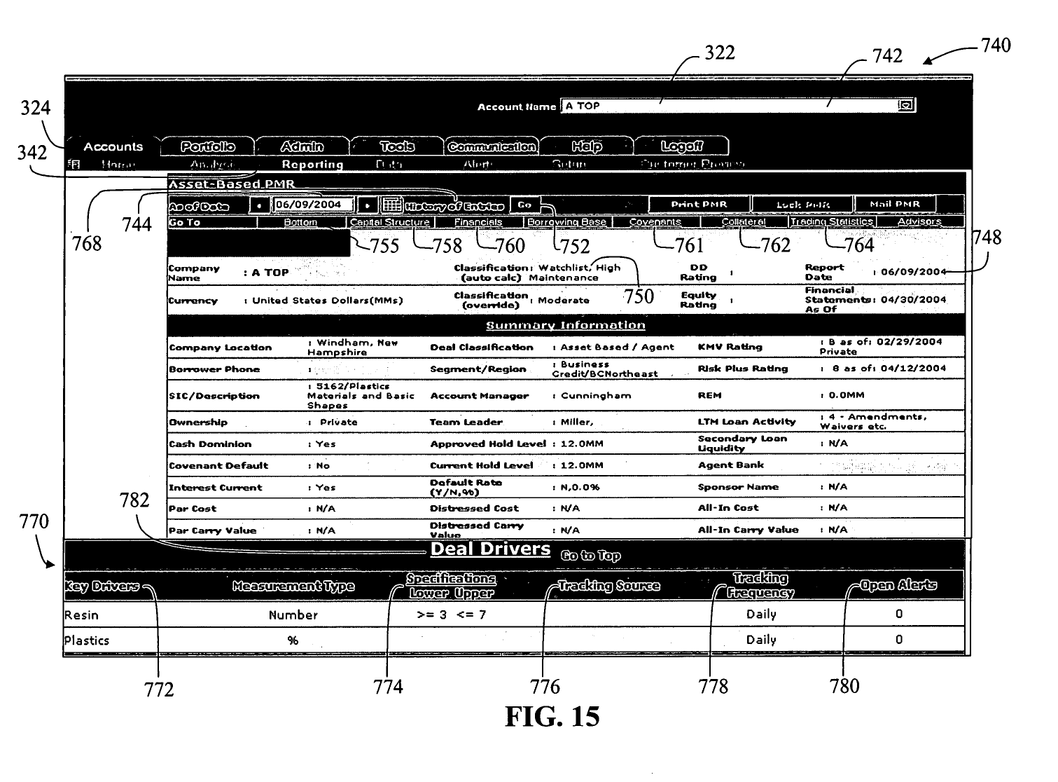

FIG. 15 is an example embodiment of a user interface 740 displaying an asset-based Portfolio Management Report (PMR) page for selected account 322, which is displayed after menu tab Accounts 324 and sub-menu tab Reporting 342 are selected by a user. User interface 740 displays at least one of graphical and tabular analyses of selected account 322. In the example embodiment, user interface 740 displays for selected account 322 a summary of current loan balances, an amount of collateral, a resulting availability of credit, an effective advance rate, letters of credit, and other information relating to credit. User interface 740 also displays for selected account 322 a summary of loan balances, a monthly trend of changes in collateral balances, and an amount of collateral availability.

User interface 740 displays an account specific report used by management within the CF Business to monitor each account 322, also known as the Analyzed Business. User interface 740 displays a report based on RM information 106 (shown in FIG. 3) which is stored in RMCS 10 (shown in FIG. 1). The standard report includes at least one of asset-based accounts, cash-flow accounts, equity accounts, Bank Loan Group (BLG) accounts, and WatchList account.

In the example embodiment, user interface 740 displays an Account Name pull-down field 742 showing selected account 322. User interface 740 also displays a Summary Information Section, a Background Section (not shown), a Recent Events and Loan Activities Section (not shown), a Guarantors/Security Section (not shown), a Capital Structure Section (not shown), a Fee Structure Section (not shown), a Financial Performance Section (not shown), a Balance Sheet Section (not shown), a Financial Commentary Section (not shown), a Borrowing Base Section (not shown), a Covenants Section (not shown), a Collateral Information Section (not shown), a Trading Statistics Section (not shown), and a Liquidation Value Section (not shown). User interface 740 also displays an As of Date data field 744, a Report Date label 748, a Risk Classification field 750, a Go button 752, a Top button (not shown), a Bottom button 755, a Background button (not shown), a Capital Structure button 758, a Financials button 760, a Covenants button 761, a Collateral button 762, and a Trading Statistics button 764.

User interface 740 also displays a History of Entries link 768, which enables a user to identify when a financial record was last saved within RMCS 10. After a user selects History of Entries link 768, a calendar is displayed (not shown) that highlights the last time a specific financial record was saved within RMCS 10.

In the example embodiment, user interface 740 also includes a deal driver section 770 displaying deal specific key drivers. Section 770 includes key drivers 772 for a specific deal, specifications 774 for each key driver, a tracking source 776 for each key driver, a tracking frequency 778 for each key driver, and open alerts 780. In the example embodiment, deal driver section 770 also includes a Deal Specific Key Driver link 782, which accesses a deal driver setup page.

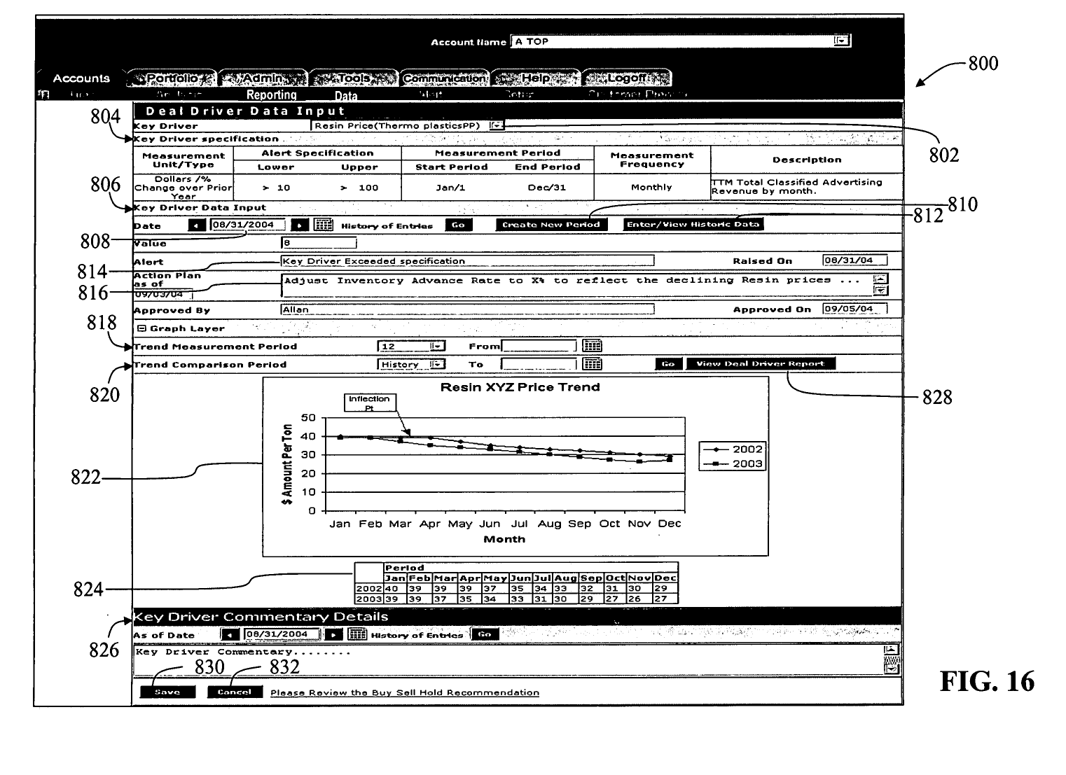

FIG. 16 is an example embodiment of a user interface 800 displaying a deal driver data input page included within RMCS 10 (shown in FIG. 1). User interface 800 can be displayed by selecting Deal Specific Key Driver link 782 (shown in FIG. 15) in deal driver section 770 (shown in FIG. 15). User interface 800 enables a user to enter data relating to key drivers for a particular deal.

In the example embodiment, user interface 800 includes at least one of key driver pull-down list 802, a key driver specification section 804, a key driver data input section 806, a date data field 808, a create new period button 810, an enter/view historic data button 812, an alert data field 814, an Action Plan data field 816, a trend measurement period 818, a trend comparison period 820, a trend graph 822, a period data section 824, a key driver commentary details section 826, a view deal driver report button 828, a save button 830, and a cancel button 832.

In the example embodiment, period data section 824 is populated based on the deal setup page including a measurement frequency and driver start date. Trend measurement period 818 includes a number of periods the user wants to graph. If “All” is selected the trend comparison period will be populated with “History”. Trend comparison period 820 indicates how information will be compared including at least one of Yr/Yr, LTM, YTD, and History. History will show data.

Alert data field 814 includes alerts that have not been populated with an action plan and approved by a SVP. An alert date is the date of the alert. An action plan includes a detail description of an Account Manager (AM) actions to be taken as a result of an alert. An action plan date is the date the action plan was entered. An alert review and action plan approval indicates whether an indicated SVP or SRO has approved an AM's action plan. An approval date is a date of approval.

The key driver commentary details section 826 includes detail commentary relating to a driver including at least, but not limited to, tends, comparison and outlook.

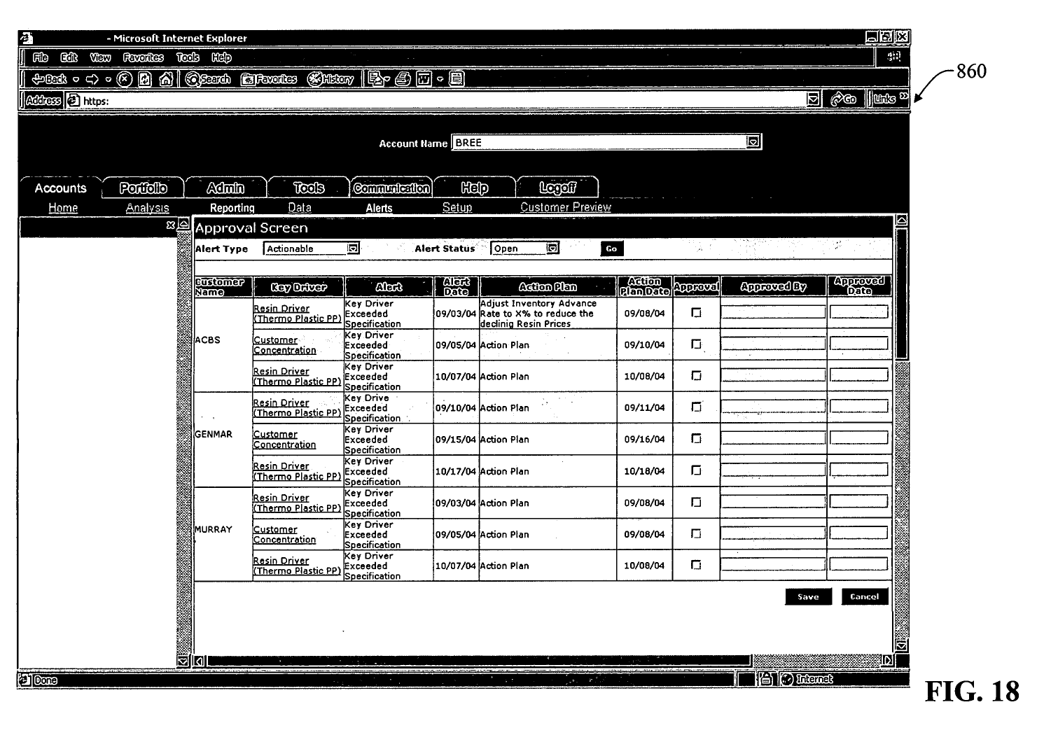

If a deal driver is out of the specification when the save button is selected, a pop-up box will warn a user and question the user as to whether the user wishes to continue. Upon saving user interface 800, an action plan e-mail is sent to the SVP for approval. The view button will link to PMR deal driver report (shown in FIG. 18). Alerts will be sent at the end of the day via e-mail with hot link to user interface 800.

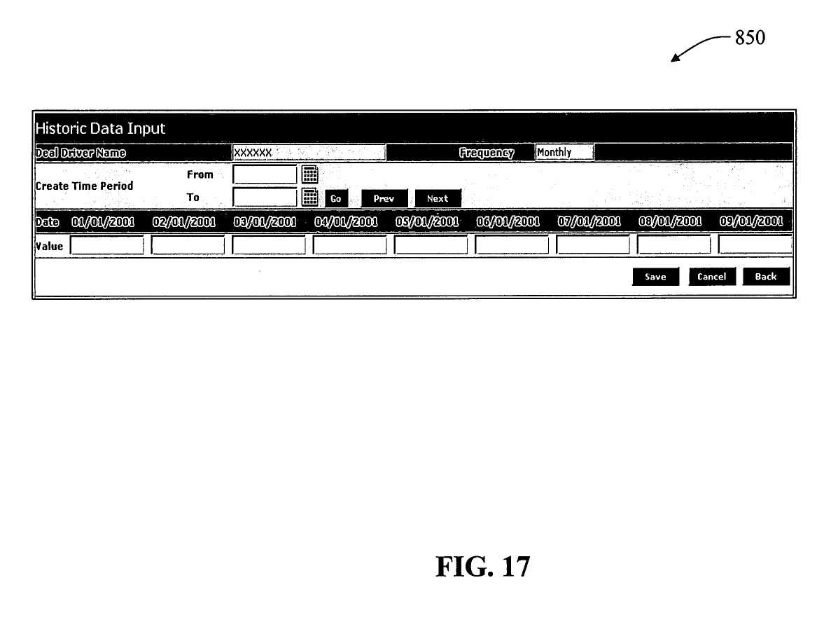

FIG. 17 is an example embodiment of a user interface 850 displaying an historical data input pop-up window included within RMCS 10 (shown in FIG. 1). User interface 850 is a pop-up window accessed and displayed within deal driver data input page 800 (shown in FIG. 16). User interface 850 enables a user to input historical data relating to specific risk drivers (e.g., price of copper) back in time so that trends can be monitored from an historical perspective.

FIG. 18 is an example embodiment of a user interface 860 displaying a deal driver approval/alert page included within RMCS 10 (shown in FIG. 1). User interface 860 displays at least an alert type pull-down list, an alert status pull-down list, and a Go button. User interface 860 displays in tabular form information relating to each customer. The table includes a customer name column, a key driver column, an alert column, an alert date column, an action plan column, an action plan date column, an approval column, an approved by column, and an approved date column.

In the example embodiment, user interface 860 is used by Senior Vice Presidents (SVPs) to approve action plans and is used by Account Managers (AMs), Team Leaders (TLs), and SVPs to monitor alerts that have tripped according to the business rules set up for each alert.

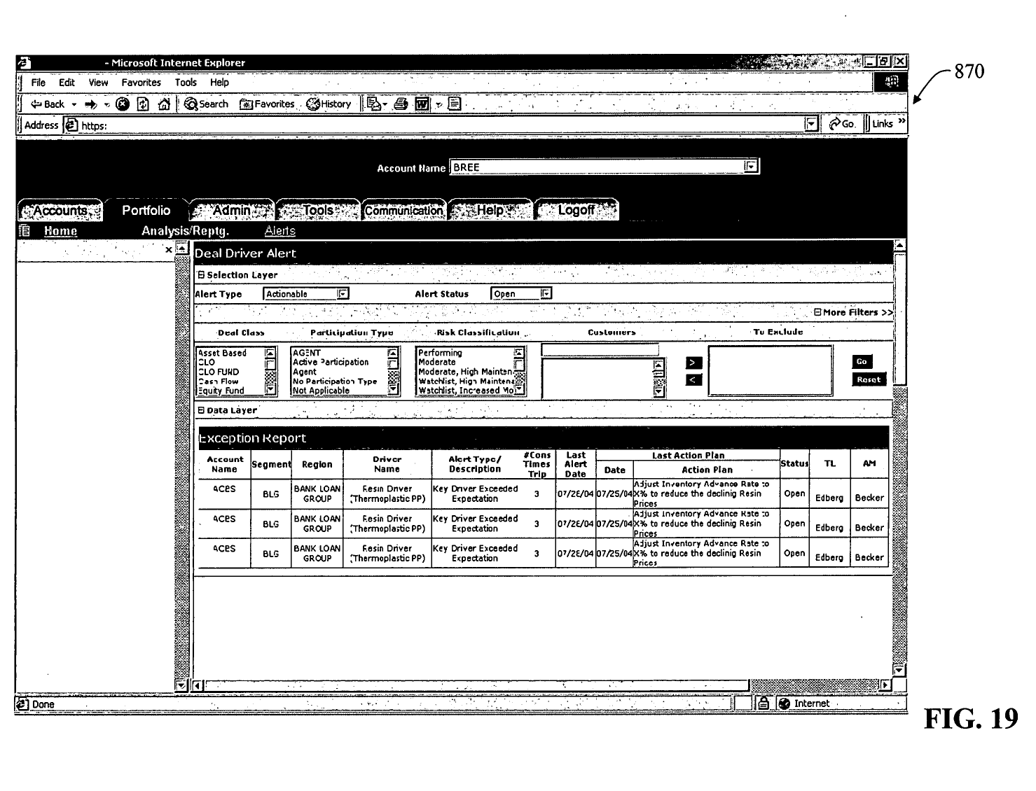

FIG. 19 is an example embodiment of a user interface 870 displaying a deal driver alert page included within RMCS 10 (shown in FIG. 1). User interface 870 displays at least one of an alert type pull-down list, and an alert status pull-down list. User interface 870 also enables a user to perform a search using a plurality of search filters including at least one of a deal class filter, a participation type filter, a risk classification filter, a customers filter, and a to exclude filter.

User interface 870 also displays in tabular form an exception report section including an account name column, a segment column, a region column, a driver name column, an alert type/description column, a last alert column, a date column, an action plan column, a status column, a TL column, and an AM column.

In the example embodiment, user interface 870 is used by Senior Risk Officers (SROs) to monitor alerts that have tripped according to the business rules set up for each alert.

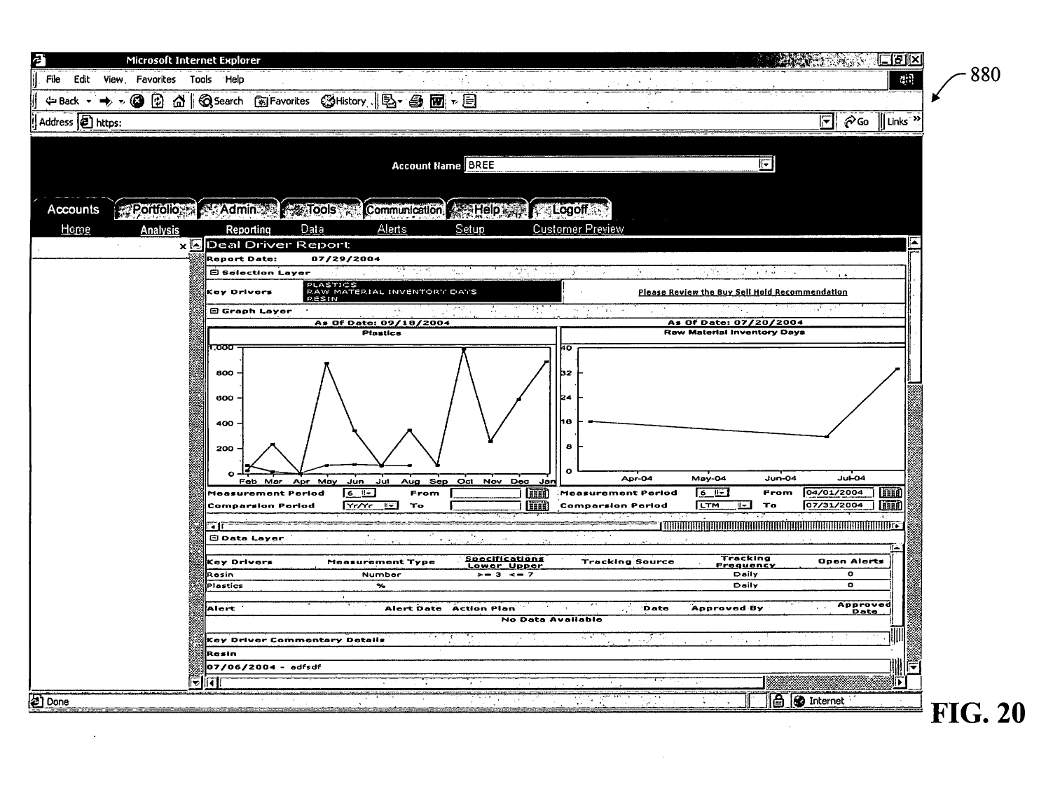

FIG. 20 is an example embodiment of a user interface 880 displaying a deal driver report page included within RMCS 10 (shown in FIG. 1). User interface 880 displays data showing deal specific drivers for each account with trends, alert specifications (i.e., business rules for each alert), status of current tripped alerts (if any), and commentary.

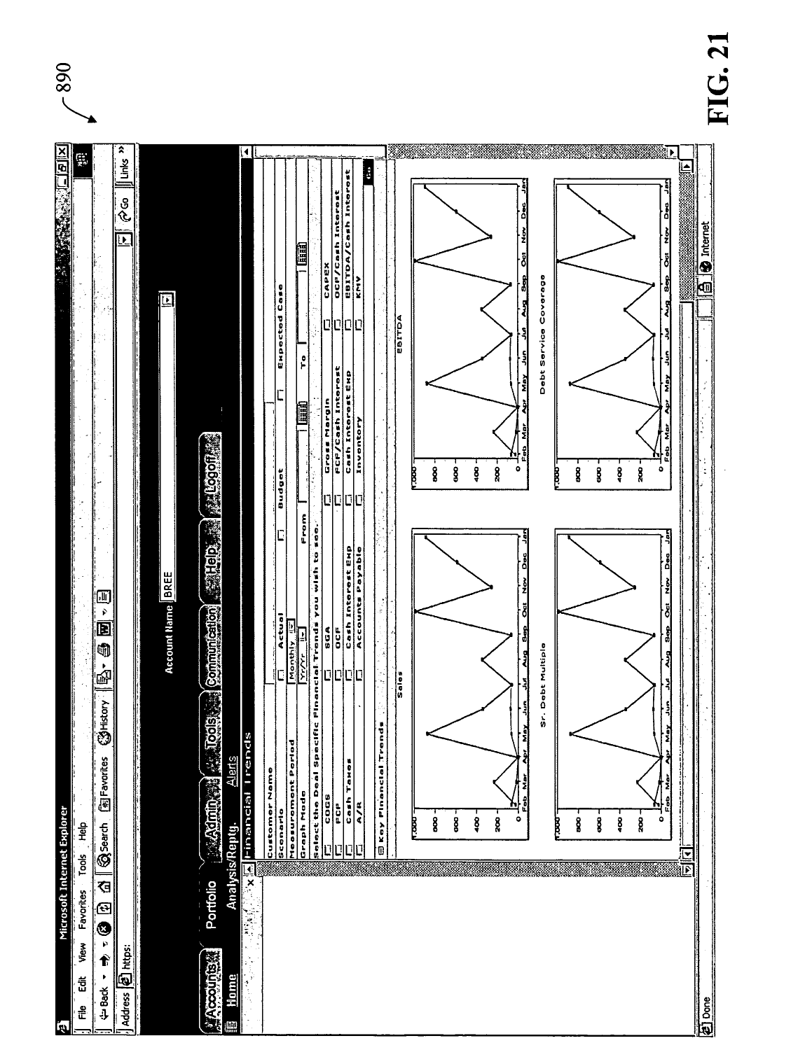

FIG. 21 is an example embodiment of a user interface 890 displaying a financial trends report page included within RMCS 10 (shown in FIG. 1). User interface 890 is displayed when a user selects financial trends under Analysis tab 340 (shown in FIG. 7A) of RMCS 10. In the example embodiment, at least four (4) financial trends graphs are displayed on user interface 890 including Sales, EBITDA, Sr. Debt Multiple, and Debt Service Coverage. In addition, Account Managers can select to display graphs showing other trends.

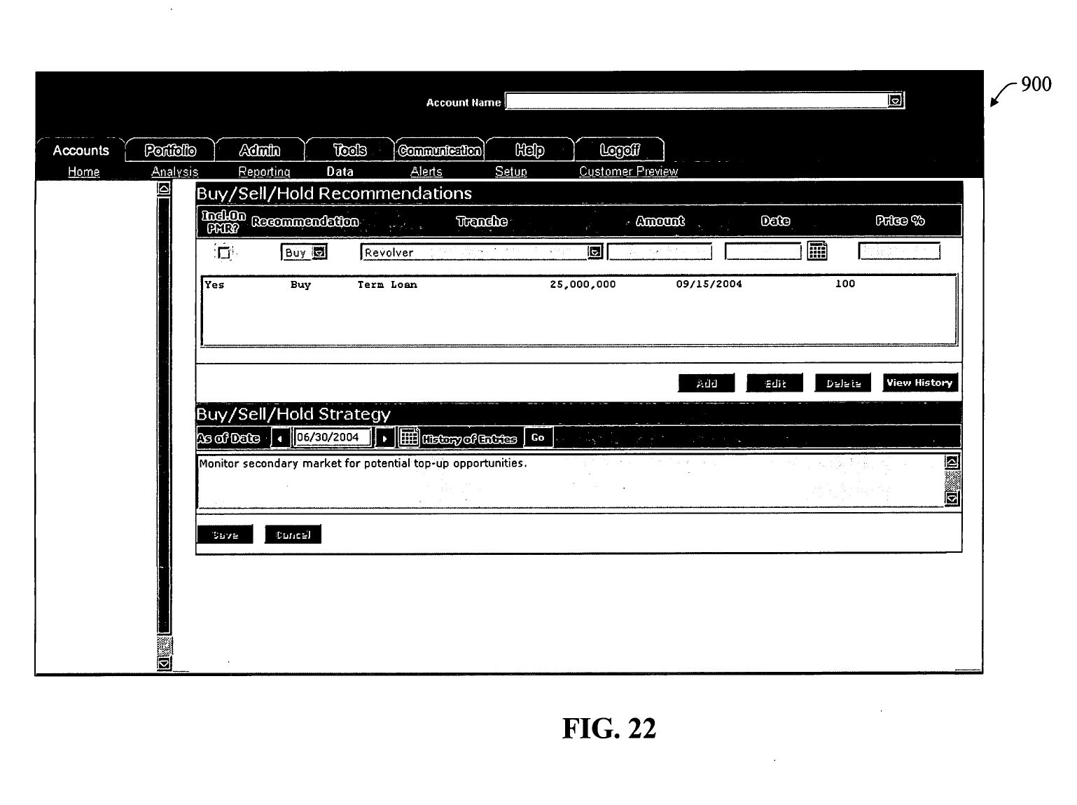

FIG. 22 is an example embodiment of a user interface 900 displaying a Buy/Sell/Hold page included within RMCS 10 (shown in FIG. 1). User interface 900 is displayed when a user selects the Buy/Sell/Hold link 357 included within user interface 320 (shown in FIGS. 7A-7B). User interface 900 shows the supporting data for a Buy/Sell/Hold recommendation.

RMCS therefore better enables a business engaging in complex deals, such as commercial financing, mergers, acquisitions and real estate transactions, to collect, manage, store and disseminate RM information among internal deal teams and selected outside deal teams so as to facilitate a more accurate and efficient analysis of the risks associated with a deal and to facilitate management of workload and personnel. More specifically, RMCS enables the CF Business to input RM information on a single occasion and into a single computer workstation that may be located at various locations, permits the various internal deal teams within the CF Business to share RM information when conducting a due diligence analysis and to continue account management of the Analyzed Business, and enables the CF Business to provide RM information to outside deal teams, like outside legal counsel, during the due diligence analysis. The RMCS also enables a user to monitor a plurality of accounts included in a portfolio, and monitor a plurality of portfolios. Additionally, the RMCS enables a deal team leader to manage a workload of an account manager as well as enabling a senior risk officer to manage a workload of team leaders. The RMCS therefore permits the CF Business to devote more time to analyzing RM information and conducting the due diligence analysis, and less time entering, checking and reporting data.

RMCS also allows a business engaging in complex deals to generate a plurality of financial scenarios for a customer involved in a deal, and then compare the financial scenario numbers with actual financial numbers for the customer at some point in the future after the deal has been closed. The RMCS enables the financing business to compare actual financial numbers for a customer to an expected financial scenario at any point in the future after the deal has been closed. By so doing, the financing business can calculate a variance between the expected scenario and actual. The financing business can also evaluate and revise its underwriting processes based on such comparisons.

The RMCS also allows a financing business to monitor each account or deal after closing. RMCS prompts a deal team member to enter at least one of key risk factors, a key driver, a data source, a monitoring frequency, a target metric, a trigger level, an impact of factor, and actions required for each account included within RMCS. The RMCS monitors these key risk factors for each account, and automatically notifies the deal team and management for the financing business if a trigger level for one of the monitored key risk factors has been satisfied. The financing business can then determine whether the account management strategy should be modified which may include creating or updating a Buy/Sell/Hold action plan.

While the invention has been described in terms of various specific embodiments, those skilled in the art will recognize that the invention can be practiced with modification within the spirit and scope of the claims.

1. A method for managing business information and account strategy by a business entity using a computer system coupled to a database, said method comprising:
receiving at the computer system information including historical financial data relating to at least one customer of the business entity;
storing the information received at the computer system in the database;
entering into the computer at least one risk factor including at least one of a deal driver, a tracking source, a tracking frequency, a target metric, a trigger level, an impact of factor, and corresponding action plan, the risk factor indicating a risk associated with the business entity providing financing to the customer;
storing the at least one risk factor in the database;
updating the database periodically with newly received information including actual financial data for the customer to maintain the database; and
monitoring the at least one deal driver to determine whether to alter a current account strategy being applied by the business entity to the customer including updating a buy/hold/sell plan.

2. A method in accordance with claim 1 further comprising:
generating at least one financial scenario for the customer based on the received information, the at least one financial scenario including projected financial data for the customer;
storing the at least one financial scenario in the database; and
calculating a variance for the customer by comparing the projected financial data from the generated financial scenario to the actual financial data.

3. A method in accordance with claim 2 wherein generating at least one financial scenario for the customer further comprises:
providing a cash flow forecasting tool in communication with the computer system;
accessing by the forecasting tool the information stored in the database; and
projecting future financial data for the customer using the forecasting tool and the information stored in the database.

4. A method in accordance with claim 3 wherein projecting future financial data for the customer further comprises:
using the forecasting tool to project a variety of financial scenarios for the customer;
storing the financial scenarios in the database; and
determining by the business entity whether to provide the customer with financing based on the financial scenarios stored in the database.

5. A method in accordance with claim 2 wherein generating at least one financial scenario for the customer further comprises projecting an expected financial scenario for the customer.

6. A method in accordance with claim 2 wherein calculating a variance for the customer further comprises calculating a plurality of metrics showing a comparison between the projected financial data and the actual financial data for the customer over a specific period time.

7. A method in accordance with claim 2 wherein calculating a variance for the customer further comprises calculating an EBITDA (Earnings Before Interest, Taxes, Depreciation and Amortization) percentage based on the projected financial data and the actual financial data for the customer over a specific period of time.

8. A method in accordance with claim 2 wherein calculating a variance for the customer further comprises:
evaluating an underwriting process used by the business entity prior to providing financing to the customer; and
determining whether to alter the underwriting process for future financings based on the calculated variance.

9. A method in accordance with claim 1 wherein receiving at the computer system information further comprises receiving at the computer system risk management (RM) information for a customer of the business entity, the RM information comprising at least one of business information, accounts payable, accounts receivable, an availability analysis, a covenant compliance, coverage ratios, financial statements, financial statement and availability projections, a capital structure, income statements, an inventory, a leverage analysis, a loan profile, collateral, guarantors, machinery and equipment, real estate, a liquidation value, amortization information, a capital raising history, an equity valuation, and other documents and information relating to the financial condition of the customer.

10. A method in accordance with claim 1 wherein entering into the computer at least one risk factor further comprises entering into the computer a deal driver and at least one of a type of deal driver, a deal driver rationale, a tracking source, a detailed driver description, a measurement frequency, a measurement start date, a measurement end date, and whether the deal driver is a seasonal driver.

11. A method in accordance with claim 1 wherein entering into the computer at least one risk factor further comprises entering into the computer at least one deal driver and a corresponding trigger level for each financing, the deal driver is assigned by the business entity during an underwriting process associated with the financing of the customer and includes a financial variable representing a level of strength of the customer's business, the trigger level is assigned to a deal driver by the business entity during the underwriting process associated with the financing of the customer and is a threshold level such that when a trigger level is satisfied the computer automatically notifies management of the business entity.

12. A method in accordance with claim 1 wherein entering into the computer at least one risk factor further comprises:
entering into the computer at least one deal driver for each financing, wherein each deal driver is assigned by a deal team associated with the business entity during an underwriting process associated with the financing of the customer and is approved by management of the business entity; and
updating the corresponding action plan as required by the financing.

13. A method in accordance with claim 1 wherein monitoring the at least one deal driver further comprises:
monitoring by the business entity a deal driver associated with a financing provided by the business entity to the customer, the deal driver including a financial variable representing a level of strength of the customer's business, the deal driver having a corresponding trigger level;
using the tracking source to determine a value for the deal driver;
comparing the value of the deal driver from the tracking source to the corresponding trigger level; and
automatically notifying management of the business entity if the value of the deal driver from the tracking source satisfies the corresponding trigger level.

14. A method in accordance with claim 13 wherein automatically notifying management comprises transmitting an electronic message to at least one of an account manager, a team leader, a portfolio manager, and a senior risk manager from at least one of a member of a deal team, an account manager, a team leader, a portfolio manager, and a senior risk manager.

15. A method in accordance with claim 1 wherein monitoring the at least one deal driver further comprises:
monitoring by the business entity a deal driver associated with a financing provided by the business entity to the customer, the deal driver including a financial variable representing a level of a strength of the customer's business, the deal driver having a corresponding trigger level and action plan;
using the tracking source to determine a value for the deal driver;
comparing the value of the deal driver from the tracking source to the corresponding trigger level; and
implementing the action plan if the value of the deal driver from the tracking source satisfies the corresponding trigger level.

16. A method in accordance with claim 1 wherein monitoring the at least one deal driver further comprises:
monitoring by the business entity a deal driver associated with a financing provided by the business entity to the customer, the deal driver including a financial variable representing a level of strength of the customer's business, the deal driver having a corresponding trigger level;
using the tracking source to determine a value for the deal driver;
comparing the value of the deal driver from the tracking source to the corresponding trigger level; and
determining by the business entity if the value of the deal driver from the tracking source satisfies the corresponding trigger level whether to alter the current account strategy including at least one of providing additional financing to the customer, selling the financing provided to the customer, and maintaining the financing provided to the customer.

17. A method in accordance with claim 1 wherein monitoring the at least one deal driver further comprises:
inputting historical data relating to deal drivers; and
monitoring trends of deal drivers over a period of time for a specific financing.

18. A method in accordance with claim 1 wherein the computer system is a server system, and wherein the method further comprises connecting the server system with a client system via a network that includes one of a wide area network, a local area network, an intranet and the Internet.

19. A method for managing business information and account strategy by a business entity using a computer system coupled to a database, said method comprising:
receiving at the computer system information including historical financial data relating to at least one customer of the business entity;
storing the information received at the computer system in the database;
generating at least one financial scenario for the customer based on the received information, the at least one financial scenario including projected financial data for the customer;
entering into the computer at least one risk factor including at least one of a deal driver, a tracking source, a tracking frequency, a target metric, a trigger level, an impact of factor, and corresponding action plan, the risk factor indicating a risk associated with the business entity providing financing to the customer, the deal driver is assigned by the business entity during an underwriting process associated with the financing of the customer and includes a financial variable representing a level of strength of the customer's business, the trigger level is assigned to a deal driver by the business entity during the underwriting process associated with the financing of the customer and is a threshold level;
storing the at least one financial scenario and the at least one risk factor in the database;
updating the database periodically with newly received business information including actual financial data for the customer to maintain the database;
calculating a variance for the customer by comparing the projected financial data from the generated financial scenario to the actual financial data; and
monitoring the at least one deal driver to determine whether to alter a current account strategy being applied by the business entity to the customer including updating a buy/hold/sell plan.

20. A network based system for managing business information and account strategy by a business entity, said system comprising:
a client system comprising a browser;
a centralized database for storing information;
a server system configured to be coupled to the client system and the database, the server system further configured to:
receive from the client system information including historical financial data relating to at least one customer of the business entity;
store the information in the database;
prompt a user to enter using the client system at least one risk factor including at least one of a deal driver, a tracking source, a tracking frequency, a target metric, a trigger level, an impact of factor, and corresponding action plan, the risk factor indicating a risk associated with the business entity providing financing to the customer;
store the at least one risk factor in the database;
update the database periodically with newly received information including actual financial data for the customer to maintain the database; and
monitor the at least one deal driver to determine whether to alter a current account strategy being applied by the business entity to the customer including updating a buy/hold/sell plan.

21. A system in accordance with claim 20 wherein said server system is further configured to:
generate at least one financial scenario for the customer based on the received information, the at least one financial scenario including projected financial data for the customer;
store the at least one financial scenario in the database; and
calculate a variance for the customer by comparing the projected financial data from the generated financial scenario to the actual financial data.

22. A system in accordance with claim 21 further comprising a cash flow forecasting tool in communication with the server system, the cash flow forecasting tool configured to:
access the information stored in the database; and
project future financial data for the customer based on the information stored in the database.

23. A system in accordance with claim 22 wherein the cash flow forecasting tool is further configured to:
project a variety of financial scenarios for the customer; and
store the financial scenarios in the database.

24. A system in accordance with claim 23 wherein said server system is further configured to:
provide a recommendation to the business entity regarding whether to provide the customer with a financing based on the financial scenarios stored in the database.

25. A system in accordance with claim 21 wherein the at least one financial scenario for the customer includes an expected financial scenario, and wherein said server system is further configured to store the expected financial scenario in the database.

26. A system in accordance with claim 21 wherein said server system is further configured to calculate a plurality of metrics showing a comparison between the projected financial data and the actual financial data for the customer over a specific period of time.

27. A system in accordance with claim 21 wherein said server system is further configured to calculate an EBITDA (Earnings Before Interest, Taxes, Depreciation and Amortization) percentage based on the projected financial data and the actual financial data for the customer over a specific period of time.

28. A system in accordance with claim 21 wherein said server system is further configured to:
evaluate an underwriting process used by the business entity prior to providing financing to the customer; and
recommend whether to alter the underwriting process for future financings based on the calculated variance.

29. A system in accordance with claim 20 wherein information stored in the database further comprises risk management (RM) information for a customer of the business entity, the RM information comprising at least one of business information, accounts payable, accounts receivable, an availability analysis, a covenant compliance, coverage ratios, financial statements, financial statement and availability projections, a capital structure, income statements, an inventory, a leverage analysis, a loan profile, collateral, guarantors, machinery and equipment, real estate, a liquidation value, amortization information, a capital raising history, an equity valuation, and other documents and information relating to the financial condition of the customer.

30. A system in accordance with claim 20 wherein said server system is further configured to prompt a user to enter into the client system a deal driver and at least one of a type of deal driver, a deal driver rationale, a tracking source, a detailed driver description, a measurement frequency, a measurement start date, a measurement end date, and whether the deal driver is a seasonal driver.

31. A system in accordance with claim 20 wherein said server system is further configured to:
prompt a user to enter into the client system at least one deal driver and a corresponding trigger level for each financing, the deal driver is assigned by the business entity during an underwriting process associated with the financing of the customer and includes a financial variable representing a level of strength of the customer's business, the trigger level is assigned to a deal driver by the business entity during the underwriting process associated with the financing of the customer and is a threshold level; and
automatically transmit a notification to management of the business entity when a trigger level is satisfied.

32. A system in accordance with claim 20 wherein said server system is further configured to:
prompt a user to enter into the client system at least one deal driver for each financing, wherein each deal driver is assigned by a deal team associated with the business entity during an underwriting process associated with the financing of the customer and is approved by management of the business entity; and
prompt the user to update the corresponding action plan as required by the financing.

33. A system in accordance with claim 20 wherein said server system is further configured to:
monitor a deal driver associated with a financing provided by the business entity to the customer, the deal driver including a financial variable representing a level of strength of the customer's business, the deal driver having a corresponding trigger level;
access the tracking source to determine a value for the deal driver;
compare the value of the deal driver from the tracking source to the corresponding trigger level; and
automatically notify management of the business entity if the value of the deal driver from the tracking source satisfies the corresponding trigger level.

34. A system in accordance with claim 33 wherein said server system is further configured to transmit an electronic message to at least one of an account manager, a team leader, a portfolio manager, and a senior risk manager from at least one of a member of a deal team, an account manager, a team leader, a portfolio manager, and a senior risk manager.

35. A system in accordance with claim 20 wherein said server system is further configured to:
monitor a deal driver associated with a financing provided by the business entity to the customer, the deal driver including a financial variable representing a level of a strength of the customer's business, the deal driver having a corresponding trigger level and action plan;
access the tracking source to determine a value for the deal driver;
compare the value of the deal driver from the tracking source to the corresponding trigger level; and
display on the client system the action plan if the value of the deal driver from the tracking source satisfies the corresponding trigger level.

36. A system in accordance with claim 20 wherein said server system is further configured to:
monitor a deal driver associated with a financing provided by the business entity to the customer, the deal driver including a financial variable representing a level of strength of the customer's business, the deal driver having a corresponding trigger level;
access the tracking source to determine a value for the deal driver;
compare the value of the deal driver from the tracking source to the corresponding trigger level; and
prompt the user, if the value of the deal driver from the tracking source satisfies the corresponding trigger level, to alter the current account strategy including at least one of providing additional financing to the customer, selling the financing provided to the customer, and maintaining the financing provided to the customer.

37. A system in accordance with claim 20 wherein said server system is further configured to:
prompt a user to input into the client system historical data relating to deal drivers; and
display on the client system trends of deal drivers over a period of time for a specific financing.

38. A system in accordance with claim 20 wherein the server system is connecting to the client system via a network that includes one of a wide area network, a local area network, an intranet and the Internet.

39. A computer program embodied on a computer readable medium for managing business information and account strategy by a business entity providing financing to a customer, said program comprising at least one code segment that receives information including historical financial data relating to at least one customer of the business entity and then:
stores the information in a database;
prompts a user to enter at least one risk factor including at least one of a deal driver, a tracking source, a tracking frequency, a target metric, a trigger level, an impact of factor, and corresponding action plan, the risk factor indicating a risk associated with the business entity providing financing to the customer;
stores the at least one risk factor in the database;
updates the database periodically with newly received information including actual financial data for the customer to maintain the database;
monitors the at least one deal driver; and
recommends whether to alter a current account strategy being applied by the business entity to the customer including updating a buy/hold/sell plan.

40. A computer program in accordance with claim 39 further comprising at least one code segment that:
generates at least one financial scenario for the customer based on the received information, the at least one financial scenario including projected financial data for the customer;
stores the at least one financial scenario in the database; and
calculates a variance for the customer by comparing the projected financial data from the generated financial scenario to the actual financial data.

41. A computer program in accordance with claim 40 further comprising at least one code segment that:
transmits information from the database to a cash flow forecasting tool; and
receives projected future financial data for the customer from the cash flow forecasting tool.

42. A computer program in accordance with claim 41 further comprising at least one code segment that:
receives a variety of financial scenarios for the customer from the cash flow forecasting tool; and
stores the financial scenarios in the database.

43. A computer program in accordance with claim 42 further comprising at least one code segment that:
provides a recommendation to the business entity regarding whether to provide the customer with a financing based on the financial scenarios stored in the database.

44. A computer program in accordance with claim 40 further comprising at least one code segment that stores an expected financial scenario in the database.

45. A computer program in accordance with claim 40 further comprising at least one code segment that calculates a plurality of metrics showing a comparison between the projected financial data and the actual financial data for the customer over a specific period of time.

46. A computer program in accordance with claim 40 further comprising at least one code segment that calculates an EBITDA (Earnings Before Interest, Taxes, Depreciation and Amortization) percentage based on the projected financial data and the actual financial data for the customer over a specific period of time.

47. A computer program in accordance with claim 40 further comprising at least one code segment that:
evaluates an underwriting process used by the business entity prior to providing financing to the customer; and
recommends whether to alter the underwriting process for future financings based on the calculated variance.

48. A computer program in accordance with claim 39 further comprising at least one code segment that stores risk management (RM) information of the customer in the database including at least one of business information, accounts payable, accounts receivable, an availability analysis, a covenant compliance, coverage ratios, financial statements, financial statement and availability projections, a capital structure, income statements, an inventory, a leverage analysis, a loan profile, collateral, guarantors, machinery and equipment, real estate, a liquidation value, amortization information, a capital raising history, an equity valuation, and other documents and information relating to the financial condition of the customer.

49. A computer program in accordance with claim 39 further comprising at least one code segment that prompts a user to enter a deal driver and at least one of a type of deal driver, a deal driver rationale, a tracking source, a detailed driver description, a measurement frequency, a measurement start date, a measurement end date, and whether the deal driver is a seasonal driver.

50. A computer program in accordance with claim 39 further comprising at least one code segment that:
prompts a user to enter at least one deal driver and a corresponding trigger level for each financing, the deal driver is assigned by the business entity during an underwriting process associated with the financing of the customer and includes a financial variable representing a level of strength of the customer's business, the trigger level is assigned to a deal driver by the business entity during the underwriting process associated with the financing of the customer and is a threshold level; and
automatically transmits a notification using a computer system to management of the business entity when a trigger level is satisfied.

51. A computer program in accordance with claim 39 further comprising at least one code segment that:
monitors a deal driver associated with a financing provided by the business entity to the customer, the deal driver including a financial variable representing a level of strength of the customer's business, the deal driver having a corresponding trigger level;
accesses the tracking source to determine a value for the deal driver;
compares the value of the deal driver from the tracking source to the corresponding trigger level; and
automatically notifies management of the business entity if the value of the deal driver from the tracking source satisfies the corresponding trigger level.

52. A computer program in accordance with claim 39 further comprising at least one code segment that:
monitors a deal driver associated with a financing provided by the business entity to the customer, the deal driver including a financial variable representing a level of a strength of the customer's business, the deal driver having a corresponding trigger level and action plan;
accesses the tracking source to determine a value for the deal driver;
compares the value of the deal driver from the tracking source to the corresponding trigger level; and
displays on a client system the action plan if the value of the deal driver from the tracking source satisfies the corresponding trigger level.

53. A computer program in accordance with claim 39 further comprising at least one code segment that:
monitors a deal driver associated with a financing provided by the business entity to the customer, the deal driver including a financial variable representing a level of strength of the customer's business, the deal driver having a corresponding trigger level;
accesses the tracking source to determine a value for the deal driver;
compares the value of the deal driver from the tracking source to the corresponding trigger level; and
prompts the user, if the value of the deal driver from the tracking source satisfies the corresponding trigger level, to alter the current account strategy including at least one of providing additional financing to the customer, selling the financing provided to the customer, and maintaining the financing provided to the customer.

54. A computer program in accordance with claim 39 further comprising at least one code segment that:
prompts a user to input into a client system historical data relating to deal drivers; and
displays on the client system trends of deal drivers over a period of time for a specific financing.
